(19) United States
(12) Patent Application Publication
(10) Pub. No.: US 2026/0091491 A1
(43) Pub. Date: Apr. 2, 2026

(54) SKILL LEARNING AND ADAPTATION FOR ROBOTIC DEVICES VIA MULTIMODAL HUMAN INTERACTION

(71) Applicant: IntuitiveMotion.Al, Inc., New York, NY (US)

(72) Inventors: Xiaoxi Liu, Boston, MA (US); Yuchen Cui, Los Angeles, CA (US)

(73) Assignee: IntuitiveMotion.Al, Inc., New York, NY (US)

(21) Appl. No.: 19/341,077

(22) Filed: Sep. 26, 2025

Related U.S. Application Data
(60) Provisional application No. 63/700,012, filed on Sep. 27, 2024.

(51) Int. Cl. B25J 9/16

(52) U.S. Cl. CPC B25J 9/163; B25J 9/1653; B25J 9/1664; B25J 9/1669

(57) ABSTRACT

A system for robotic skill learning and adaptation including a processor configured to receive and integrate inputs including visual data from multimodal control sources for controlling robotic platforms, process the integrated inputs to enhance robotic task planning and execution capabilities using large language models and computer vision algorithms, direct robotic movements based on the processed input from the foundation model integration module, perform real-time quality assessment during operation of the robotic platform, retrieve and store robotic task execution data, and providing the robotic task execution data to the robotic platforms upon request, adapt robotic behavior across multiple robotic platforms by analyzing data, updating the shareable knowledge base, and modifying robotic control parameters based on the updated knowledge base.

### CROSS-REFERENCE TO RELATED APPLICATION

This application claims priority to U.S. Provisional Application No. 63/700,012, filed September 27, 2024, which is incorporated by reference in its entirety.

### FIELD

The present disclosure generally relates to skill learning and adaptation for robotic devices via multimodal human interaction. In some aspects, the disclosure may provide systems and methods for enhancing robotic capabilities through various input modalities, including but not limited to voice commands, visual cues, feedback from remote interfaces and force feedback from human operators.

### BACKGROUND

Robotic systems have become increasingly prevalent in various industries, from manufacturing to healthcare. These systems typically rely on pre-programmed instructions or manual control by skilled operators to perform tasks. Recent advancements in artificial intelligence and machine learning have led to the development of more sophisticated robotic control systems that can adapt to changing environments and learn new skills over time. These systems often incorporate natural language processing, computer vision, and other advanced technologies to enhance their capabilities and ease of use.

Despite these advancements, current robotic systems face several challenges. Many require extensive programming and technical expertise to operate effectively, limiting their accessibility to non-technical users. Additionally, the transfer of skills between different robotic platforms or across various operational domains remains a significant hurdle. Existing systems often struggle to provide seamless human-robot collaboration, particularly in dynamic environments where safety constraints are important. Furthermore, the ability to continuously learn and improve performance based on real-time feedback and experiences across multiple robotic units is limited in many current implementations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, the present disclosure relates to a system for robotic skill learning and adaptation, comprising a processor configured to execute a multimodal input processing module configured to receive and integrate inputs including visual data from multimodal control sources for controlling robotic platforms, a foundation model integration module configured to process the integrated inputs from the multimodal input processing module to enhance robotic task planning and execution capabilities using large language models and computer vision algorithms, a robotic control module configured to direct robotic movements based on the processed input from the foundation model integration module, a quality control module configured to perform real-time quality assessment during operation of the robotic platform, a shareable knowledge base configured to retrieve and store robotic task execution data from the foundation model integration module and the robotic control module, and providing the robotic task execution data to the robotic platforms upon request, and a continuous learning module configured to adapt robotic behavior across multiple robotic platforms by analyzing data from the robotic control module and the quality control module, updating the shareable knowledge base, and controlling the robotic control module to modify robotic control parameters based on the updated knowledge base.

In embodiments of this aspect, the disclosure according to any one of the above example embodiments, the multimodal input processing module is configured to select between plane segmentation-based grasp planning and model-based pose estimation using a three-dimensional mesh library based on object characteristics and occlusion conditions.

In embodiments of this aspect, the disclosure according to any one of the above example embodiments, the processor comprises a dual-environment processing architecture with edge processing components configured for real-time robotic control operations and cloud-based components configured for model training and knowledge base updates.

In embodiments of this aspect, the disclosure according to any one of the above example embodiments, the quality control module is further configured to perform defect detection and contamination assessment using computer vision algorithms trained on domain-specific datasets.

In embodiments of this aspect, the disclosure according to any one of the above example embodiments, the continuous learning module is configured to incrementally increase autonomous operation levels based on intervention rate metrics, grasp success rates, and cycle time performance data.

In embodiments of this aspect, the disclosure according to any one of the above example embodiments, the shareable knowledge base comprises a versioned three-dimensional mesh library for domain-specific objects and cross-platform adaptation logic for transferring skills between the robotic platforms.

In embodiments of this aspect, the disclosure according to any one of the above example embodiments, the continuous learning module is configured to track intervention rates and manipulation success metrics, and a feedback integration component configured to request and process human operator manipulations of the robotic platform.

In embodiments of this aspect, the disclosure according to any one of the above example embodiments, the continuous learning module is configured to update manipulation strategies and quality assessment parameters in the shareable knowledge base based on a performance of the robotic platform.

In embodiments of this aspect, the disclosure according to any one of the above example embodiments, the processor is configured to execute a behavior tree control framework configured to orchestrate manipulation sequences including object detection, grasp planning, quality assessment, and containerization operations.

In embodiments of this aspect, the disclosure according to any one of the above example embodiments, the system is configured for domain-configurable operation across a plurality of industrial applications including at least one of dishware handling, food service automation, and manufacturing assembly tasks.

In one aspect, the present disclosure relates to a method for robotic skill learning and adaptation, comprising receiving and integrating inputs including visual data from multimodal control sources for controlling robotic platforms, processing the integrated inputs to enhance robotic task planning and execution capabilities using large language models and computer vision algorithms, directing robotic movements based on the processed input, performing real-time quality assessment during operation of the robotic platform, retrieving and storing robotic task execution data and providing the robotic task execution data to the robotic platforms upon request, and adapting robotic behavior across multiple robotic platforms by analyzing data from the robotic control and the quality assessment, updating a knowledge base, and modifying robotic control parameters based on the updated knowledge base.

In embodiments of this aspect, the disclosure according to any one of the above example embodiments, further comprising receiving and integrating inputs by selecting between plane segmentation-based grasp planning and model-based pose estimation using a three-dimensional mesh library based on object characteristics and occlusion conditions.

In embodiments of this aspect, the disclosure according to any one of the above example embodiments, further comprising processing the integrated inputs by executing a dual-environment processing architecture with edge processing components for real-time robotic control operations and cloud-based components for model training and knowledge base updates.

In embodiments of this aspect, the disclosure according to any one of the above example embodiments, further comprising performing real-time quality assessment by performing defect detection and contamination assessment using computer vision algorithms trained on domain-specific datasets.

In embodiments of this aspect, the disclosure according to any one of the above example embodiments, further comprising adapting robotic behavior by incrementally increasing autonomous operation levels based on intervention rate metrics, grasp success rates, and cycle time performance data.

In embodiments of this aspect, the disclosure according to any one of the above example embodiments, further comprising retrieving and storing robotic task execution data by maintaining a versioned three-dimensional mesh library for domain-specific objects and cross-platform adaptation logic for transferring skills between the robotic platforms.

In embodiments of this aspect, the disclosure according to any one of the above example embodiments, further comprising adapting robotic behavior by tracking intervention rates and manipulation success metrics, and requesting and processing human operator manipulations of the robotic platform.

In embodiments of this aspect, the disclosure according to any one of the above example embodiments, further comprising adapting robotic behavior by updating manipulation strategies and quality assessment parameters in the knowledge base based on a performance of the robotic platform.

In embodiments of this aspect, the disclosure according to any one of the above example embodiments, further comprising executing a behavior tree control framework to orchestrate manipulation sequences including object detection, grasp planning, quality assessment, and containerization operations.

In embodiments of this aspect, the disclosure according to any one of the above example embodiments, further comprising deploying a domain-configurable operation across a plurality of industrial applications including at least one of dishware handling, food service automation, and manufacturing assembly tasks.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1A illustrates a system architecture for robotic skill learning and adaptation, according to aspects of the present disclosure.

FIG. 1B illustrates a processing platform with edge and cloud components for the system architecture of FIG. 1A, according to aspects of the present disclosure.

FIG. 1C illustrates a method for robotic grasping behavior using the system architecture of FIG. 1A, according to aspects of the present disclosure.

FIG. 1D illustrates a control system for the robotic system of FIG. 1A, according to aspects of the present disclosure.

FIG. 2A illustrates a flowchart of a method for robotic skill learning and adaptation, according to aspects of the present disclosure.

FIG. 2B illustrates a flowchart of a method for configuring dual-environment processing architecture, according to aspects of the present disclosure.

FIG. 3A illustrates a flowchart of a staged learning process method, according to aspects of the present disclosure.

FIG. 3B illustrates a flowchart of a method for progressive autonomy in robotic systems, according to aspects of the present disclosure.

FIG. 4A illustrates a flowchart of a method for interpreting and processing multimodal inputs, according to aspects of the present disclosure.

FIG. 4B illustrates a flowchart of a method for robotic manipulation and quality control, according to aspects of the present disclosure.

FIG. 5A illustrates a flowchart of a method for robotic skill acquisition and transfer, according to aspects of the present disclosure.

FIG. 5B illustrates a flowchart of a method for managing versioned mesh libraries and skill adaptation, according to aspects of the present disclosure.

FIG. 6A illustrates a flowchart of a method for continuous learning and improvement, according to aspects of the present disclosure.

FIG. 6B illustrates a flowchart of a method for processing intervention data and updating system behavior, according to aspects of the present disclosure.

The foregoing general description of the illustrative embodiments and the following detailed description thereof are merely exemplary aspects of the teachings of this disclosure and are not restrictive.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

The present disclosure relates to a system and method for robotic skill learning and adaptation. This system and method may address the challenges faced by current robotic systems, such as the need for extensive programming and technical expertise, limited skill transfer capabilities, and difficulties in human-robot collaboration. In some aspects, the disclosed system and method may leverage advanced technologies, including artificial intelligence, machine learning, and multimodal inputs, to enhance the adaptability and learning capabilities of robotic platforms across various industries and operational domains.

In one example, the system for robotic skill learning and adaptation may receive multimodal inputs from a human operator through various interfaces such as voice commands, visual cues, or force feedback where physical contact occurs between the robot and the human operator (e.g., the human operator pushes/pulls the robot to perform a positional correction). These inputs may be processed by the foundation model integration module, which utilizes large language models and computer vision algorithms to interpret the instructions and plan appropriate robotic actions. The robotic control module may then direct the movements of the robotic platforms based on this processed input. As the robotic systems perform tasks, the continuous learning module may analyze their performance, integrate feedback, and update the shareable knowledge base, allowing for ongoing improvement and adaptation of robotic behaviors across multiple platforms.

Benefits of this system may include enhanced accessibility for non-technical users, as it allows for intuitive multimodal interactions without requiring extensive programming knowledge. The system's ability to transfer skills between different robotic platforms and operational domains may increase versatility and scalability. Continuous learning and adaptation capabilities may enable the robotic systems to improve their performance over time, reducing the need for manual reprogramming. The integration of safety constraints and real-time obstacle detection may enhance secure operation in dynamic environments. Additionally, multi-agent collaboration features may allow for efficient management and coordination of tasks across multiple robotic units, potentially improving overall productivity and resource utilization in various industrial applications.

In one configuration, the system may incorporate software such as a multimodal input processing module, a foundation model integration module, a robotic control module, a shareable knowledge base, and a continuous learning module. These components may interact to enable remote control of robotic platforms through multimodal inputs, enhance robotic task planning and execution capabilities using large language models and computer vision algorithms, direct robotic movements based on processed inputs, retrieve and store robotic task execution data, and adapt robotic behavior across multiple robotic platforms. The continuous learning module may analyze data from the robotic control module and update the shareable knowledge base, facilitating the continuous improvement of robotic skills and behaviors. The system may also include a safety constraint module for implementing predefined safety standards, ensuring secure robotic operation in dynamic environments. The shareable knowledge base may further include a cross-platform adaptation logic for transferring skills between different robotic platforms, promoting versatility and scalability in robotic operations.

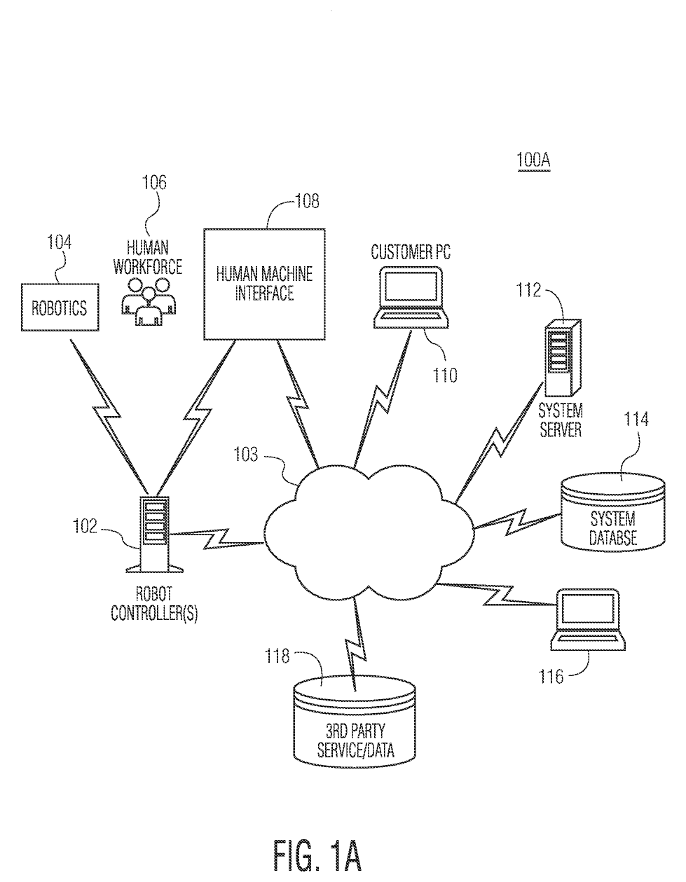

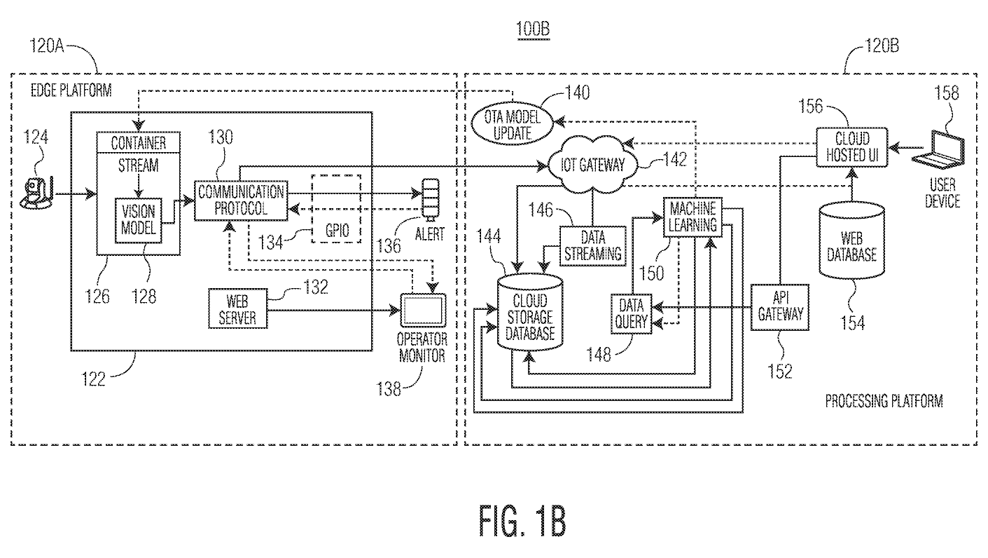

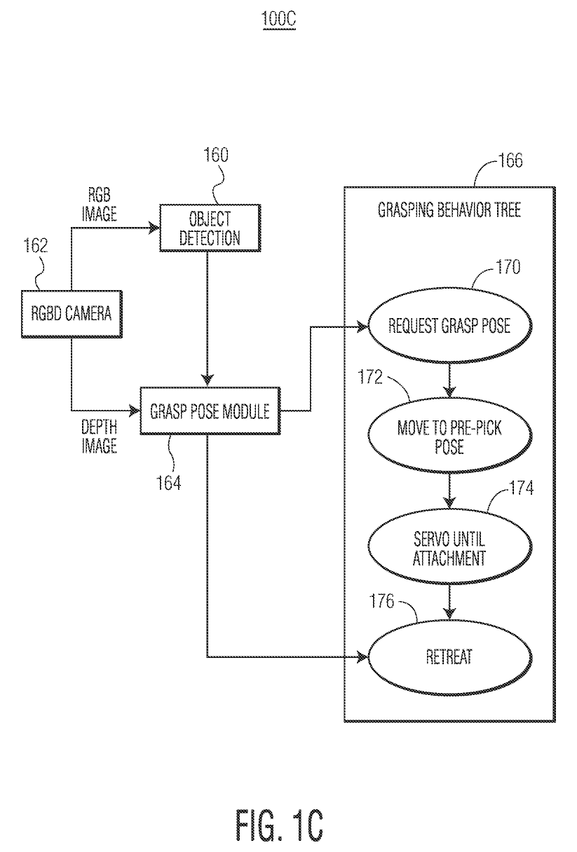

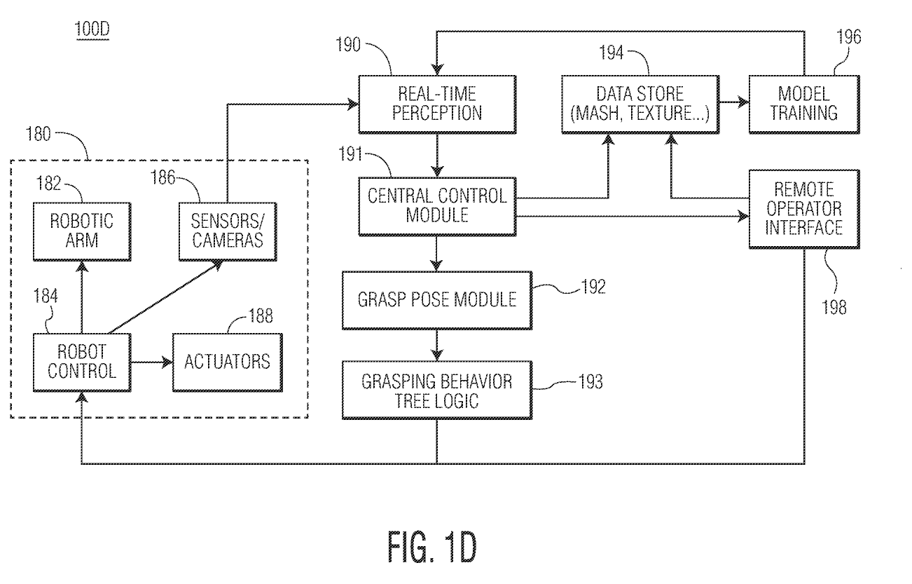

Referring to FIG. 1A, the system 100 for robotic skill learning and adaptation may include several interconnected components that facilitate communication and control between robotic systems, human operators, and various computational resources and facilitate execution of software modules.

In some aspects, the modules that are software executing on the hardware such as multimodal input processing module, foundation model integration module, robotic control module, safety constraint module, and continuous learning module. These modules (described below) may interact to enable remote control, task planning, movement execution, safety monitoring, and ongoing learning for the robotic platforms.

For example, system 100 may include a multimodal input processing module, represented by the human-machine interface 108, which may be configured to receive and integrate inputs from multimodal control sources for controlling robotic platforms. These control sources may include, but are not limited to, voice commands, visual cues, and force (i.e., tactile, haptic, etc.) feedback from human operators or other input devices. In some aspects, the multimodal input processing module may include cameras for capturing visual data, virtual reality headsets for immersive control interfaces, remote controls for wireless operation, and touch panels for direct manipulation of robotic systems. The module may also incorporate speech recognition systems for voice commands, force sensors for haptic feedback, and motion capture devices for gesture-based control of robotic platforms.

The system 100 may also include a robotic control module, represented by the robot controller 102, which may be configured to direct robotic movements based on processed input from the foundation model integration module. The robotic control module may include a hardware abstraction layer for controlling robotic configurations. This layer may allow the system 100 to interface with a variety of robotic platforms, represented by the robotics 104, regardless of their specific hardware configurations. This feature may enhance the system's versatility, enabling it to control a wide range of robotic devices from simple robotic arms to complex autonomous vehicles.

The robot controller 102 may be connected to the robotics 104, allowing it to manage the operations and movements of the robotic systems. In some aspects, the robot controller 102 may communicate with the robotics 104 through other hardware, enabling control of various robotic configurations regardless of their specific hardware implementations.

The system 100 may further include a foundation model integration module, which may be configured to process the integrated inputs from the multimodal input processing module to enhance robotic task planning and execution capabilities. This module may utilize large language models and computer vision algorithms to interpret natural language instructions, recognize visual cues, and plan appropriate robotic actions. In some cases, the foundation model integration module may be implemented within the system server 112, which may handle data processing tasks for system 100.

The system 100 may also include a shareable knowledge base, represented by the system database 114, which may be configured to retrieve and store robotic task execution data from the foundation model integration module and the robotic control module. The shareable knowledge base may provide the robotic task execution data to the robotic platforms upon request, facilitating the transfer of learned skills and operational data between different robotic systems.

The system 100 may further include a continuous learning module, which may be configured to adapt robotic behavior across multiple robotic platforms. The continuous learning module may analyze data from the robotic control module and update the shareable knowledge base, facilitating the continuous improvement of robotic skills and behaviors. In some cases, the continuous learning module may be implemented within the system control center 116, which may oversee the overall operation and learning processes of the system 100.

In some aspects, the system 100 may also include a safety constraint module, which may be configured to implement predefined safety standards for secure robotic operation. This module may include real-time obstacle detection and dynamic environment adaptation capabilities, ensuring safe operation of the robotic systems in dynamic environments. The safety constraint module may be integrated within the robot controller 102 or may be implemented as a separate component within the system 100.

In some cases, the system 100 may also be connected to third party services 118, allowing it to integrate external data sources or services into its operations. This feature may enhance the system's capabilities, enabling it to leverage external resources for tasks such as data analysis, machine learning, or cloud storage. In some cases, the third-party services 118 may include cloud computing platforms that provide additional processing power or storage capacity for the system 100. These services may also encompass specialized machine learning APIs that can enhance the system's analytical capabilities. Additionally, the third party services 118 may include external databases or knowledge repositories that can supplement the system's existing knowledge base with domain-specific information or real-time data feeds.

Having described the various software components, the following section delves into the specific hardware details of the robotic skill learning and adaptation system. This section may provide insights into the physical components, computational resources, and networking infrastructure that enable the system's functionality. The hardware description may cover aspects such as processing units, memory systems, sensors, actuators, and communication interfaces that form the backbone of the robotic platforms and their associated control systems.

In one example, system 100 may include robotics 104, human workforce 106, human-machine interface 108, robot controller 102, customer computer 110, system server 112, system database 114, system control center 116, and third-party services 118 which are connected via network 103.

The robot controller 102 may be a specialized computing device designed to manage and control the operations of the robotics 104. In some aspects, the robot controller 102 may include high-performance processors, real-time operating systems, and specialized software for robotic control. The robot controller 102 may also incorporate safety systems, motion planning algorithms, and interfaces for various sensors and actuators.

In some cases, the robot controller 102 may include advanced networking capabilities to facilitate real-time communication with other components of the system 100. These networking features may enable low-latency data exchange between the robot controller 102 and the robotics 104, as well as with other system components such as the system server 112 and the system control center 116. The robot controller 102 may also incorporate machine learning algorithms that allow it to adapt and optimize its control strategies based on operational data and feedback from the continuous learning module. This adaptive capability may enable the robot controller 102 to improve its performance over time, enhancing the efficiency and effectiveness of the robotic operations it manages.

The robotics 104 may encompass a wide range of robotic platforms, including but not limited to robotic arms, autonomous mobile robots, and collaborative robots. In some cases, the robotics 104 may include various sensors such as cameras, lidar, force sensors, and proximity sensors. The robotics 104 may also incorporate actuators, motors, and end effectors tailored to specific tasks or industries.

In some aspects, the robotics 104 may be equipped with advanced artificial intelligence and machine learning capabilities, enabling them to adapt to changing environments and learn from experience. These AI-powered robots may utilize neural networks and deep learning algorithms to improve their performance over time, enhancing their ability to handle complex tasks and make decisions in real-time. The robotics 104 may also feature modular designs, allowing for easy customization and reconfiguration to suit different applications. This modularity may extend to both hardware and software components, enabling rapid deployment and adaptation of robotic systems across various industries and use cases. Additionally, the robotics 104 may incorporate advanced communication protocols, such as 5G or industrial internet of things (IoT) standards, to facilitate seamless integration with other systems and enable real-time data exchange for improved coordination and performance.

The human workforce 106 may represent the human operators and supervisors who interact with and oversee the robotic systems. In some aspects, the human workforce 106 may include skilled technicians, engineers, and operators trained in robotic system management and control. In some cases, the human workforce 106 may include unskilled workers that interact with the robot, but are not skilled in robotic technology such as programming.

In some cases, the human workforce 106 may also include domain experts from various industries who provide specialized knowledge and insights to optimize robotic operations in specific contexts. These experts may collaborate with the technical team to develop custom workflows, define task parameters, and refine robotic behaviors for industry-specific applications. The human workforce 106 may also encompass trainers and educators who develop and implement training programs for new operators, ensuring a continuous pipeline of skilled personnel capable of managing and interacting with the evolving robotic systems. Additionally, the human workforce 106 may include human-robot interaction specialists who focus on improving the ergonomics and usability of the robotic systems, enhancing the overall efficiency and safety of human-robot collaboration in various operational environments.

In some cases, human-machine interface 108 may include various input devices that allow for multimodal interaction between human operators and the robotic systems. In some cases, the human-machine interface 108 may include a video camera for capturing visual data from the environment or the human operator. The video camera may be used to recognize visual cues such as gestures or object characteristics, which may be used to guide the robotic systems. In some aspects, the human-machine interface 108 may also include a virtual reality headset, which may provide an immersive interface for the human operator to interact with the robotic systems. The virtual reality headset may allow the human operator to view the operational environment from the perspective of the robotic systems, enhancing their control and understanding of the tasks.

In some cases, the human-machine interface 108 may include a mobile device, which may provide a portable and convenient interface for controlling the robotic systems. The mobile device may include a touchscreen interface, allowing the human operator to input commands through gestures or on-screen controls. In some aspects, the human-machine interface 108 may also include a game controller, which may provide a familiar and intuitive control interface for the human operator. The game controller may include various buttons, joysticks, or other control elements that can be mapped to specific commands or actions for the robotic systems.

In some cases, the human-machine interface 108 may include a speech interface, which may allow the human operator to control the robotic systems through voice commands. The speech interface may include a microphone for capturing the human operator's voice and a speech recognition system for interpreting the voice commands. The speech interface may allow for natural and intuitive interaction with the robotic systems, reducing the need for technical expertise or complex control interfaces.

The customer computer 110 may be a standard desktop or laptop computer equipped with specialized software for monitoring and controlling the robotic systems. In some cases, the customer computer 110 may include high-resolution displays for detailed visualization of robotic operations and performance metrics.

In some aspects, the customer computer 110 may be equipped with advanced data visualization tools that allow for real-time monitoring and analysis of robotic system performance. These tools may include interactive dashboards, 3D modeling capabilities, and customizable reporting features that enable users to gain deep insights into the operational efficiency of the robotic systems. The customer computer 110 may also incorporate remote access capabilities, allowing authorized personnel to monitor and control robotic operations from off-site locations. This feature may enhance the flexibility and responsiveness of the system, enabling rapid decision-making and troubleshooting even when operators are not physically present at the robotic installation site.

The system server 112 may be a high-performance computing system designed to handle the data processing and computational tasks for system 100. In some aspects, the system server 112 may incorporate parallel processing capabilities and high-speed storage systems to manage the complex computations for robotic control and learning.

Additionally, the system server 112 may be equipped with specialized software tools that optimize the processing of large datasets and real-time data streams, which are beneficial for the dynamic operation of robotic systems. These tools may include data analytics frameworks, machine learning libraries, and real-time processing engines that can handle the simultaneous inputs and outputs beneficial for the continuous adaptation and learning of the robots. The integration of these tools may allow the system server 112 to efficiently process and analyze data from multiple sources, including sensors on the robots, input from human operators, and external data feeds, ensuring that the robotic systems can respond quickly and accurately to changes in their environment or operational parameters. This capability is beneficial for maintaining high levels of performance and reliability in complex and rapidly changing industrial settings.

The system database 114 may be a robust, scalable database system designed to store and manage large volumes of operational data, learned skills, and system configurations. In some cases, the system database 114 may utilize distributed storage systems and advanced data management techniques to ensure high availability and fast data retrieval.

In some aspects, the system database 114 may incorporate advanced data compression techniques to optimize storage efficiency and reduce data retrieval times. These compression algorithms may be specifically tailored to handle the unique characteristics of robotic operational data, such as time-series sensor readings and multi-dimensional motion trajectories. The system database 114 may also implement intelligent caching mechanisms that anticipate frequently accessed data patterns, further enhancing system responsiveness. Additionally, the database may feature built-in data analytics capabilities, allowing for real-time processing and analysis of stored information. This may enable the system to generate insights and performance metrics without the need for extensive data transfers to external analysis systems.

The system control center 116 may be a centralized facility equipped with advanced monitoring and control systems. In some aspects, the system control center 116 may include large display walls for visualizing system-wide operations, dedicated workstations for system administrators, and redundant communication systems to ensure continuous operation.

In some cases, the system control center 116 may incorporate advanced data analytics and artificial intelligence capabilities to provide real-time insights and predictive maintenance recommendations. These capabilities may enable the system administrators to proactively identify potential issues, optimize resource allocation, and improve overall system performance. The system control center 116 may also feature a scalable architecture that allows for easy expansion and integration of new robotic systems or operational domains. This scalability may enable the control center to adapt to growing operational needs and technological advancements, ensuring that the system remains effective and efficient over time. Additionally, the system control center 116 may include collaborative workspaces and virtual meeting rooms, facilitating seamless communication and coordination between on-site personnel and remote experts or stakeholders.

The third-party services 118 may encompass a wide range of external resources and services that can be integrated with the system 100. In addition to cloud storage and machine learning services, the third-party services 118 may include specialized data analytics platforms, robotic simulation environments, and industry-specific knowledge bases. In some cases, these services may be accessed through secure application programming interfaces (APIs), allowing for seamless integration with the system 100 while maintaining data security and privacy.

In some aspects, the third-party services 118 may also include advanced robotic process automation (RPA) tools, which can be integrated with the system 100 to enhance its capabilities in automating repetitive tasks across various software applications. These RPA tools may allow the system to interact with legacy systems, web applications, and enterprise software, extending the reach of automation beyond physical robotic operations. Additionally, the third-party services 118 may incorporate blockchain technologies for secure and transparent record-keeping of robotic operations, transactions, and data exchanges. This may enhance the traceability and auditability of the system's activities, particularly in industries with strict regulatory requirements. The integration of these diverse third-party services may enable the system 100 to continuously evolve and adapt to new technological advancements and industry-specific needs, fostering innovation and improving overall operational efficiency.

Referring to FIG. 1B, the system architecture may comprise a dual-environment processing configuration that distributes computational tasks between an edge platform 120A and a processing platform 120B. This architecture may enable real-time robotic operations while maintaining continuous learning capabilities through distributed processing resources.

The edge platform 120A may include several interconnected components that facilitate real-time data processing and communication. In some aspects, the edge platform 120A may include a camera 124, which may be configured to capture visual data from the operational environment. The camera 124 may be connected to a container 126, which may house a vision model 128 for real-time perception processing. The container 126 may provide a controlled environment for executing computer vision algorithms and processing visual data streams.

Container 126 may communicate through a communication protocol 130, which may serve as a central hub for data exchange within the edge platform 120A. The communication protocol 130 may connect bi-directionally to an alert signal 136 via a GPIO interface 134, enabling hardware-level signaling and control. Additionally, the communication protocol 130 may connect bi-directionally to an operator monitor 138, which may provide real-time status information and operational feedback to human operators. A web server 132 may be connected to the operator monitor 138, providing web-based interface management capabilities and enabling remote access to monitoring functions.

Processing platform 120B may encompass cloud-based components that handle advanced computational tasks and model management. In some aspects, the processing platform 120B may include a model update module 140, which may be configured to receive updated models from a machine learning module 150 and deploy them to container 126 on the edge platform 120A. This configuration may enable over-the-air model updates without disrupting ongoing operations.

The processing platform 120B may also include an IoT gateway 142, which may manage data flows between the edge and cloud components. IoT gateway 142 may receive data from the communication protocol 130 on the edge platform 120A and from a user device 158 through a cloud interface 156. The IoT gateway 142 may connect to multiple storage and processing components, including cloud storage 144, a data streaming module 146, and a web database 154.

In some cases, the processing platform 120B may include a data query module 148, which may connect bi-directionally to the machine learning module 150 and receive data from the cloud interface 156 via an API gateway 152. Machine learning module 150 may connect bi-directionally to cloud storage 144, enabling model training operations and data analysis. Cloud interface 156 may facilitate communication with external user devices 158 and provide access to system functionality through web-based interfaces.

The dual-environment architecture may enable efficient distribution of computational workloads, with the edge platform 120A handling time perception and control tasks, while the processing platform 120B manages resource-intensive machine learning operations and data storage. This configuration may provide the benefits of low-latency edge processing while maintaining access to cloud-scale computational resources for continuous learning and model improvement.

In a use case, system in FIG. 1B may be deployed for operation in a dish handling platform. The dish handling platform may be a dish washing machine with a robotic arm. In this configuration, the edge platform 120A may be positioned directly at the dishwashing station to provide real-time processing of visual data from dishes entering and exiting the washing cycle. The robotic arm may utilize vision model 128 to identify different types of dishware, assess cleanliness levels, and coordinate proper loading and unloading sequences while the processing platform 120B handles computationally intensive machine learning tasks for continuous improvement of the dish handling algorithms.

In the context of dish handling operations, the sequence may begin when the camera 124 captures visual data of incoming dishware in the operational environment, such as plates, bowls, or utensils entering the washing area. This visual information may be immediately processed by vision model 128 housed within container 126, which analyzes the captured images to identify dish types, assess their positioning, and determine appropriate handling strategies. The container 126 may then communicate the processed visual data through communication protocol 130, which serves as the central coordination hub for the edge platform 120A. When specific conditions are met, such as detecting damaged dishware or identifying handling challenges, the communication protocol 130 may trigger an alert signal 136 via the GPIO interface 134 to notify operators of immediate attention requirements. Simultaneously, the operator monitor 138 may receive real-time status updates about the dish handling process, while the web server 132 may provide remote access capabilities for kitchen managers to monitor operations from off-site locations.

The processed dish recognition and handling data may then flow from the communication protocol 130 to the IoT gateway 142 on the processing platform 120B, where it may be integrated with additional operational information from user devices 158 accessed through the cloud interface 156. The IoT gateway 142 may distribute this combined data to multiple processing components, including storing operational records in cloud storage 144, streaming real-time performance metrics through the data streaming module 146, and maintaining dish handling logs in the web database 154. The data query module 148 may retrieve relevant historical dish handling patterns and performance data via the API gateway 152, which may then be processed by the machine learning module 150 to identify optimization opportunities and refine handling algorithms. The machine learning module 150 may access stored operational data from cloud storage 144 to train improved dish recognition and manipulation models, which may then be deployed back to the edge platform 120A through the model update module 140, completing the continuous learning cycle that enhances the robotic system's dish handling capabilities over time.

In some aspects, the system architecture may include multiple edge platforms 120A deployed across different operational locations or workstations. These distributed edge platforms 120A may all communicate with the centralized processing platform 120B enabling coordinated operations while maintaining the benefits of low-latency edge processing at each individual location.

Referring to FIG. 1C, the block diagram 100C illustrates a comprehensive robotic grasping behavior system that integrates visual perception with structured manipulation control. The system may utilize RGBD camera 162 as the sensing component, which may capture both RGB color images and depth information from the operational environment. This dual-mode imaging capability may enable the system to obtain rich three-dimensional understanding of objects and their spatial relationships within the workspace.

The visual data from the RGBD camera 162 may be processed by an object detection module 160, which may analyze the incoming RGB and depth images to identify and locate target objects within the scene. The object detection module 160 may employ computer vision algorithms to recognize various object types, determine their positions, and assess their suitability for grasping operations. This module may serve as the foundation for subsequent manipulation planning by providing accurate object identification and localization data.

The processed object information may then be forwarded to a grasp pose module 164, which may calculate appropriate grasping configurations for the identified objects. The grasp pose module 164 may analyze object geometry, orientation, and accessibility to determine suitable approach angles, grip positions, and manipulation strategies. This module may consider factors such as object stability, collision avoidance, and manipulation constraints to generate feasible grasp poses for robotic execution.

The grasping behavior tree 166 may orchestrate the complete manipulation sequence through a structured series of operational steps. The behavior tree may begin with step 170, which involves requesting a grasp pose from grasp pose module 164. This initial step may utilize visual data from one or more fixed cameras that continuously observe the scene, ensuring that the RGBD camera 162 or other imaging systems capture comprehensive scene information with minimal occlusion.

Following the camera positioning, step 170 may involve requesting a grasp pose from grasp pose module 164. This step may trigger the calculation of specific manipulation parameters based on the current object detection results and environmental conditions. The system may evaluate multiple potential grasp configurations and select the appropriate approach based on success probability and execution efficiency.

Step 172 may involve moving the robotic arm to a pre-pick pose, positioning the end effector in preparation for the actual grasping operation. This intermediate positioning may allow the system to approach the target object along a controlled trajectory while maintaining visual monitoring of the manipulation area. The pre-pick pose may be calculated to minimize collision risks and optimize the subsequent grasping motion.

Step 174 may execute a servo-controlled approach until attachment is achieved between the robotic gripper and the target object. This step may involve continuous feedback control, adjusting the robotic motion based on real-time sensor data to ensure precise contact and secure grasping. The servo control may monitor force feedback, visual confirmation, and position accuracy to determine successful object acquisition.

The grasping sequence may conclude with step 176, which executes a retreat movement to safely withdraw the grasped object from its original location. This final step may follow a predetermined trajectory that avoids obstacles and maintains object security while transitioning to subsequent manipulation tasks or object placement operations.

The interconnected nature of these components may enable seamless data flow from initial visual perception through final object manipulation, creating a robust and adaptable grasping system capable of handling diverse objects and operational scenarios.

In the context of the dish handling application, the robotic grasping behavior system illustrated in FIG. 1C may be specifically configured to manage the complex task of handling various types of dishware throughout the washing and sorting process. The RGBD camera 162 may be strategically positioned above the dishwashing area to capture both color and depth information of incoming dishes, plates, bowls, and utensils as they arrive for processing. The object detection module 160 may be trained on domain-specific datasets containing various dishware types, enabling it to distinguish between different categories of items such as ceramic plates, glass cups, stainless steel utensils, and plastic containers. This specialized recognition capability may allow the system to identify not only the type of dishware but also assess factors such as size, fragility, and optimal handling approaches for each item.

The grasp pose module 164 may calculate dish-specific grasping strategies that account for the unique characteristics of different dishware items, such as the rim-based grasping approach for plates, handle-oriented gripping for cups and mugs, or distributed contact points for fragile glassware. The grasping behavior tree 166 may execute a tailored sequence for dishware handling, beginning with step 170 to determine the appropriate grasp configuration based on the identified dishware type and its current orientation. Steps 172 through 176 may then coordinate the careful approach, secure attachment, and controlled movement of each dish item, ensuring that delicate items are handled with appropriate force limits while maintaining efficient throughput for the dishwashing operation. This systematic approach may enable the robotic system to safely and efficiently manage the diverse range of dishware encountered in commercial kitchen environments while adapting to variations in dish placement, stacking configurations, and cleanliness assessment requirements.

Referring to FIG. 1D, the control system 100D illustrates a comprehensive robotic control architecture that integrates hardware components with software modules to enable autonomous manipulation capabilities. The system may feature a robotic system 180 that includes a robotic arm 182 as the primary manipulation component, which may be controlled through a robot control 184 module that coordinates all mechanical operations and movement execution.

The robotic system 180 may incorporate sensors/cameras 186 that provide environmental sensing capabilities, capturing visual, depth, and potentially other sensory data from the operational workspace. These sensors may work in conjunction with robotic arm 184 and actuators 188 that execute the physical movements and manipulations commanded by the control system. The robotic arm 182 and actuators 188 may include motors, servos, and end-effector mechanisms that translate digital control signals into precise mechanical actions. Actuators 188 may actuate mechanical systems (not shown) such as conveyor belts that work in conjunction with robotic arm 182.

The sensor data from sensors/cameras 186 may be processed by a perception module 190 that handles real-time environmental understanding and object recognition tasks. This module may analyze incoming sensor streams to identify objects, assess their positions and orientations, and monitor changes in the operational environment. The perception module 190 may utilize computer vision algorithms and machine learning models to interpret complex visual scenes and extract relevant information for manipulation planning.

A control module 191 may serve as the central coordination hub for the robotic system, receiving processed perception data and orchestrating the overall system behavior. The control module 191 may integrate inputs from multiple sources and make high-level decisions about task execution, safety monitoring, and operational sequencing. This module may communicate with both the grasp pose module 192 and the behavior tree logic module 193 to coordinate manipulation strategies and execution sequences.

The grasp pose module 192 may calculate specific grasping configurations and approach trajectories based on object characteristics and environmental constraints identified by the perception module 190. This module may analyze object geometry, surface properties, and accessibility to determine suitable manipulation strategies. The grasp pose module 192 may generate multiple candidate approaches and select approaches based on success probability and execution efficiency.

The behavior tree logic module 193 may implement structured decision-making frameworks that organize complex manipulation tasks into manageable sequences of actions. This module may coordinate the execution of multi-step operations, handle conditional logic, and manage transitions between different operational states. The behavior tree structure may provide flexibility in task execution while maintaining systematic approaches to complex manipulation scenarios.

A data store module 194 may maintain operational data, learned experiences, and system configurations that support ongoing operations and continuous improvement. This module may store manipulation strategies, object recognition models, and performance metrics that can be accessed by other system components. The data store module 194 may also interface with a model training module 196 that processes accumulated operational data to refine and improve system capabilities over time.

The model training module 196 may analyze performance data, identify patterns in successful and unsuccessful operations, and generate updated models for deployment to the perception module 190. This training capability may enable the system to adapt to new objects, environmental conditions, and operational requirements through continuous learning processes.

A remote operator interface 198 may provide human operators with monitoring and control capabilities, receiving status information from both the control module 191 and the data store module 194. This interface may enable operators to observe system performance, intervene when necessary, and provide feedback that contributes to system learning and improvement. The remote operator interface 198 may support various interaction modalities, including visual displays, command interfaces, and feedback mechanisms that facilitate effective human-robot collaboration.

In the context of dish handling operations, the control system 100D may be specifically configured to manage the complex requirements of commercial dishwashing environments. The robotic system 180 may be deployed at dishwashing stations where the robotic arm 182 handles various types of dishware throughout the cleaning cycle. The sensors/cameras 186 may be positioned to monitor incoming dirty dishes, assess their cleanliness levels, and track the progress of items through washing, rinsing, and drying phases. The robotic arm 182 and actuators 188 may be calibrated to handle delicate glassware with gentle force profiles while maintaining sufficient grip strength for heavier ceramic plates and metal cookware. The robot control 184 may coordinate these operations to ensure smooth transitions between loading, washing, and unloading sequences while maintaining appropriate cycle times for commercial kitchen efficiency.

It is noted that the robotic system may be equipped with various types of end effectors designed to accommodate different manipulation requirements and object characteristics. The end effectors may include anthropomorphic robotic hands with multiple articulated fingers that can conform to complex object geometries and provide precise grip control for delicate items such as glassware or irregularly shaped utensils. Alternatively, the system may utilize parallel jaw grippers with adjustable force control that can securely grasp objects with parallel surfaces, such as plates or rectangular containers. Suction cup end effectors may be employed for handling smooth, non-porous surfaces like ceramic dishes or metal trays, providing reliable attachment through vacuum pressure while minimizing contact forces that could damage fragile items. In some cases, the system may incorporate hybrid end effectors that combine multiple gripping mechanisms, such as suction cups with mechanical fingers, enabling versatile handling of diverse dishware types within a single operational cycle. The selection of appropriate end effectors may be determined by factors such as object material properties, surface texture, weight distribution, and fragility requirements, with the control system automatically configuring grip parameters and approach strategies based on the identified dishware characteristics and handling constraints.

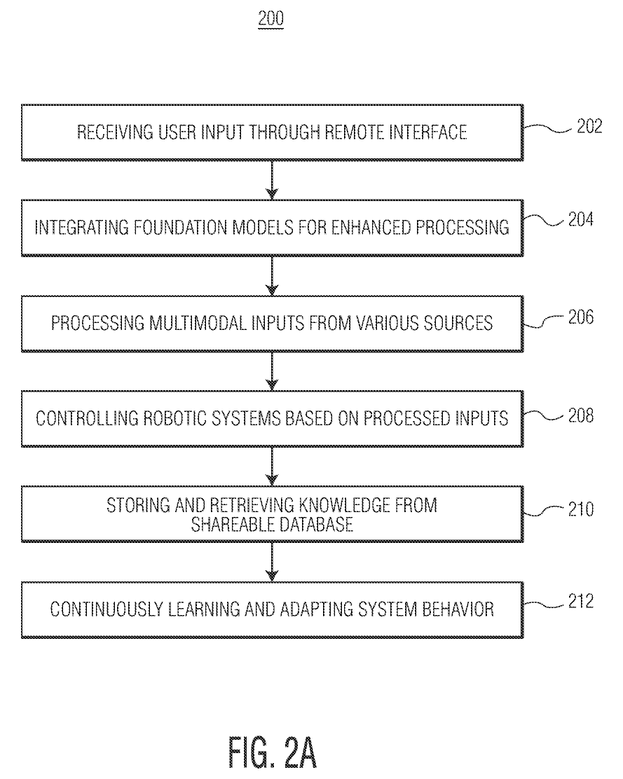

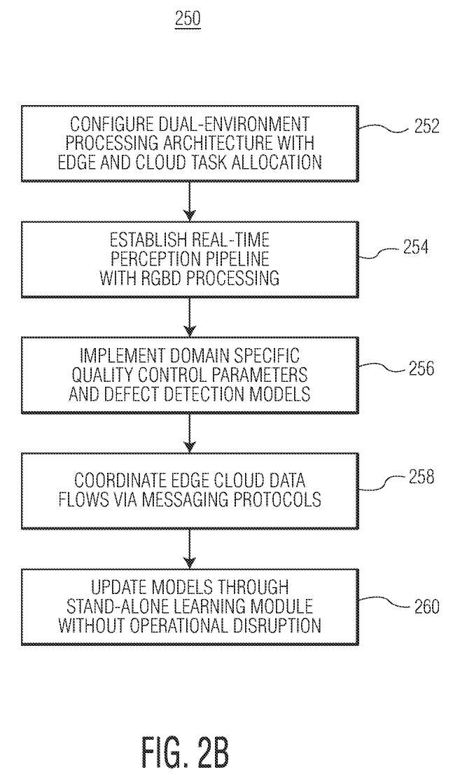

FIGS. 2A-6B are now described to explain the methods for robotic skill learning and adaptation. FIGS. 2B, 3B, 4B, 5B and 6B describe detailed implementation steps that provide specific example approaches for carrying out the methods shown in FIGS. 2A, 3A, 4A, 5A and 6A.

Referring to FIG. 2A, the method 200 for robotic skill learning and adaptation may include several steps that facilitate the receipt of user input, the integration of foundation models, the processing of multimodal inputs, and the control of robotic systems. The method 200 in FIG. 2A may include step 202 for receiving user input, step 204 for integrating foundation models, step 206 for processing multimodal inputs, step 208 for controlling robotic systems, step 210 for storing and retrieving knowledge, and step 212 for continuously learning and adapting system behavior.

The method 200 may begin with step 202, which involves receiving user input through a remote interface. This step may allow for remote operation and control of robotic systems. The user input may include, but is not limited to, voice commands, visual cues, and force feedback from human operators or other input devices.

In some aspects, the remote interface used in step 202 may incorporate advanced authentication and security measures to ensure that authorized users can access and control the robotic systems. These measures may include biometric authentication, multi-factor authentication, or role-based access control systems. The remote interface may also feature adaptive user interfaces that can adjust based on the user's expertise level, preferences, or the specific task at hand. This adaptability may enhance user experience and efficiency by presenting relevant controls and information for each user and situation. Additionally, the remote interface may include real-time collaboration tools, allowing multiple users to interact simultaneously with the robotic systems, facilitating teamwork and knowledge sharing in complex operational scenarios.

Following the receipt of user input, step 204 of the method 200 may involve integrating foundation models for enhanced processing. This step may incorporate advanced algorithms or machine learning techniques to improve data interpretation and decision-making capabilities. In some cases, the foundation models may include large language models for natural language processing and task planning. These models may interpret natural language instructions, recognize visual cues, and plan appropriate robotic actions.

In some aspects, the foundation models integrated in step 204 may also include computer vision models and reinforcement learning algorithms. These models may work in conjunction with the large language models to provide a comprehensive understanding of the operational environment and task requirements. Computer vision models may analyze visual data from cameras or other imaging devices, enabling the system to recognize objects, detect obstacles, and interpret visual cues in real-time. Reinforcement learning algorithms may allow the system to learn optimal strategies for task execution through trial and error, continuously improving performance based on feedback and rewards. The integration of these diverse foundation models may enhance the system's ability to adapt to complex and dynamic environments, making it more versatile and efficient in various industrial applications.

Step 206 of the method 200 may involve processing multimodal inputs from various sources. This step may combine different types of input data, such as visual, auditory, or haptic/tactile information, to create a comprehensive understanding of the environment and task requirements. The multimodal inputs may be processed using a variety of techniques, including but not limited to, image recognition algorithms for visual inputs, speech recognition algorithms for auditory inputs, and force sensing algorithms for haptic/tactile inputs.

In some cases, the multimodal input processing in step 206 may also incorporate advanced sensor fusion techniques to integrate data from multiple sensors and input modalities. This fusion process may involve the use of probabilistic methods, such as Kalman filters or particle filters, to combine data from different sources while accounting for uncertainties and noise in the measurements. The system may also employ deep learning architectures, such as convolutional neural networks (CNNs) for visual processing and recurrent neural networks (RNNs) for temporal data analysis, to extract high-level features from raw sensor inputs. Additionally, the multimodal input processing may include context-aware algorithms that consider the current operational state, historical data, and environmental factors to interpret and prioritize the incoming inputs more effectively. This comprehensive approach to multimodal input processing may enable the robotic system to develop a more nuanced and accurate understanding of its environment and task requirements, leading to improved decision-making and task execution capabilities.

Step 208 may involve controlling robotic systems. This step may translate the interpreted data into actionable commands for the robots. In some aspects, step 208 may utilize a hardware abstraction layer to manage various robotic configurations, allowing for flexible control across different platforms. The control commands may be optimized in real-time based on the current operational context, environmental conditions, and task requirements.

In some cases, step 208 may incorporate adaptive control algorithms that allow the robotic systems to adjust their behavior dynamically in response to changing conditions or unexpected events. These algorithms may utilize real-time sensor data and feedback from the environment to modify control parameters, ensuring increased (e.g. optimal) performance across a wide range of scenarios. The system may also employ predictive modeling techniques to anticipate future states and preemptively adjust control strategies, enhancing the responsiveness and efficiency of the robotic operations. Additionally, the control module may include fault detection and recovery mechanisms, enabling the robotic systems to identify and respond to hardware or software issues autonomously, minimizing downtime and maintaining operational continuity in complex industrial environments.

Step 210 may involve storing and retrieving knowledge from a shareable database. This step may allow the system to maintain a repository of learned information and experiences, which can be accessed and utilized across multiple robotic units or tasks. In some cases, the shareable knowledge base may incorporate cross-platform adaptation logic, enabling the transfer of skills between different robotic platforms. The knowledge base may also implement advanced indexing and retrieval mechanisms to ensure efficient access to relevant information during task execution.

In some aspects, the shareable knowledge base may implement a distributed ledger technology, such as blockchain, to enhance data integrity and traceability. This approach may provide a tamper-resistant record of knowledge transactions, including skill acquisitions, adaptations, and transfers between robotic platforms. The distributed nature of the ledger may also improve system resilience and fault tolerance, as multiple copies of the knowledge base may be maintained across different nodes in the network. Additionally, the knowledge base may incorporate natural language processing capabilities, allowing it to interpret and respond to complex queries from human operators or other robotic systems. This feature may facilitate more intuitive knowledge retrieval and enable the system to provide context-aware recommendations for task execution based on historical data and learned experiences.

Step 212 may involve continuously learning and adapting system behavior. This ongoing learning process may enable the system to refine its performance over time based on accumulated experiences and new input data. In some aspects, the continuous learning module may include performance monitoring and feedback integration components. The system may analyze task execution data, user feedback, and environmental changes to identify areas for improvement and update its operational strategies accordingly. This adaptive capability may allow the robotic system to enhance its efficiency, accuracy, and versatility across various operational domains.

In some cases, the continuous learning module may incorporate advanced machine learning techniques such as transfer learning and meta-learning to accelerate the adaptation process and improve generalization across different tasks and environments. Transfer learning may allow the system to leverage knowledge gained from one task or domain to enhance performance in related but distinct scenarios, reducing the need for extensive retraining. Meta-learning algorithms may enable the system to learn how to learn more efficiently, adapting to new tasks or environments with minimal data and computational resources. The continuous learning module may also implement a hierarchical learning architecture, where low-level skills and behaviors are refined independently of high-level task planning and decision-making processes. This hierarchical approach may allow for more targeted and efficient updates to specific components of the system's behavior, while maintaining overall stability and consistency in its operations. Additionally, the module may employ active learning strategies to identify and prioritize the informative experiences or data points for learning, optimizing the use of computational resources and accelerating the overall learning process.

In some aspects, the method 200 may also include additional steps or variations to enhance its functionality and adaptability. For example, the method may incorporate a safety constraint step to ensure secure operation of robotic systems, implementing real-time collision detection and avoidance mechanisms. The foundation model integration step may be expanded to include domain-specific models tailored to particular industries or tasks. The multimodal input processing step may be enhanced with advanced noise reduction techniques to improve input quality in challenging environments. Additionally, the method may include a multi-agent collaboration step to facilitate coordination among multiple robotic units, and a human-robot interaction step to improve the seamless integration of human operators within the robotic workflow. These variations may allow the method to be more versatile and effective across a wider range of operational scenarios and industrial applications.

In a specific use case, the method 200 may be applied to a robotic system in a dynamic commercial kitchen environment. For instance, consider a robotic arm tasked with assembling meal kits or sorting, loading, and unloading dishes in a busy restaurant setting where menu items and dish configurations frequently change.

In step 202, a human chef may use a tablet device with a touch interface and voice recognition capabilities to input new meal kit assembly instructions or dish handling procedures. The chef may speak commands to define the sequence of operations while using touch gestures to indicate precise placement locations on a 3D model of the meal kit or dishwasher rack displayed on the tablet.

During step 204, the system may integrate foundation models to interpret the chef's instructions. Natural language processing models may parse the spoken commands, while computer vision algorithms may analyze the touch gestures on the 3D model. These models may work together to generate a comprehensive plan that accounts for the spatial relationships and sequence of operations for the new meal kit assembly or dish handling procedure.

In step 206, the system may process additional multimodal inputs from various sensors in the kitchen. For example, cameras may monitor the flow of ingredients or dishes, force sensors on the robotic arm may detect the presence and orientation of food items or kitchenware, and temperature sensors may identify any anomalies in the food preparation or dishwashing process. The system may fuse this data to create a real-time understanding of the kitchen environment.

Step 208 may involve translating the processed inputs into precise control commands for the robotic arm. The system may adjust the arm's movements in real-time based on the current state of the meal kit assembly or dish handling process, ensuring accurate placement and manipulation of ingredients or kitchenware. The control module may also adapt to variations in ingredient sizes or dish shapes, maintaining consistent meal kit quality or efficient dishwashing operations.

Throughout the kitchen operations, step 210 may store information about successful meal kit assembly techniques, common errors in dish handling, and improved motion paths in the shareable knowledge base. This data may be accessed by other robotic arms in the kitchen, allowing them to quickly adapt to new menu items or dishwashing procedures without requiring individual programming.

Step 212 may involve continuous learning and adaptation as the robotic arm performs multiple meal kit assembly or dish handling cycles. The system may analyze performance metrics such as assembly time, error rates, and ingredient placement accuracy for meal kits, or sorting efficiency and breakage rates for dish handling. Based on this analysis, it may refine its strategies, optimizing movements and reducing cycle times while maintaining or improving food quality standards or dishwashing effectiveness.

Referring to FIG. 2B, method 250 for configuring dual-environment processing architecture may include several steps that facilitate the establishment and operation of distributed computational systems for robotic control. The method 250 in FIG. 2B may include step 252 for configuring dual-environment processing architecture with edge and cloud task allocation, step 254 for establishing real-time perception pipeline with RGBD processing, step 256 for implementing domain-specific quality control parameters and defect detection models, step 258 for coordinating edge-cloud data flows via messaging protocols, and step 260 for updating models through standalone learning module without operational disruption.

The method 250 may begin with step 252, which involves configuring dual-environment processing architecture with edge and cloud task allocation. This step may establish the foundational infrastructure for distributed processing across local and remote computational resources. The dual-environment configuration may involve partitioning computational tasks based on latency requirements, processing complexity, and resource availability. Edge components may be allocated time tasks such as real-time perception and immediate control responses, while cloud components may handle resource-intensive operations such as model training and large-scale data analysis.

In some aspects, the dual-environment configuration in step 252 may incorporate dynamic load balancing mechanisms that can redistribute tasks between edge and cloud resources based on current system demands and network conditions. These mechanisms may monitor computational loads, network latency, and resource utilization to optimize task allocation in real-time. The configuration may also include redundancy and failover capabilities, ensuring that operations can continue even if certain components become unavailable. Additionally, the dual-environment architecture may implement security protocols and data encryption to protect sensitive information during transmission between edge and cloud components. This comprehensive approach to system architecture may enhance both performance and reliability while maintaining data security across distributed processing environments.

Step 254 may involve establishing real-time perception pipeline with RGBD processing. This step may create a continuous data processing stream that handles both color and depth information from robotic sensors. The real-time perception pipeline may incorporate computer vision algorithms optimized for low-latency processing, enabling immediate interpretation of visual data for robotic control applications. RGBD processing may combine color image analysis with depth information to create comprehensive three-dimensional understanding of the operational environment.

In some cases, the real-time perception pipeline established in step 254 may incorporate advanced filtering and preprocessing techniques to enhance data quality and reduce computational overhead. These techniques may include noise reduction algorithms, image stabilization methods, and adaptive exposure control to maintain consistent visual data quality across varying environmental conditions. The pipeline may also implement parallel processing architectures that can handle multiple data streams simultaneously, enabling the system to process information from multiple cameras or sensors concurrently. Additionally, the perception pipeline may include predictive buffering mechanisms that anticipate data processing needs and preload relevant algorithms or models, further reducing latency in time sensitive applications. This sophisticated approach to real-time perception may enable more responsive and accurate robotic operations across diverse environmental conditions.

Step 256 may involve implementing domain-specific quality control parameters and defect detection models. This step may customize the system's quality assessment capabilities for particular operational contexts or industries. The domain-specific parameters may be tailored to recognize quality standards, defect patterns, and contamination indicators relevant to specific applications. The defect detection models may utilize machine learning algorithms trained on domain-specific datasets to identify anomalies or quality issues with high accuracy.

In some aspects, the domain-specific quality control implementation in step 256 may incorporate adaptive learning mechanisms that allow the system to refine its quality assessment criteria based on operational feedback and changing standards. These mechanisms may enable the system to learn from false positives and false negatives, continuously improving its detection accuracy over time. The quality control parameters may also include configurable thresholds and sensitivity settings that can be adjusted for different product types or quality requirements within the same operational domain. Additionally, the defect detection models may implement ensemble learning approaches, combining multiple detection algorithms to improve overall reliability and reduce the likelihood of missed defects. This comprehensive quality control framework may enhance product consistency and reduce waste while maintaining flexibility to adapt to evolving quality standards.

Step 258 may involve coordinating edge-cloud data flows via messaging protocols. This step may establish reliable communication channels between distributed system components, ensuring efficient data exchange and synchronization. The messaging protocols may handle various types of data transmission, including sensor readings, control commands, model updates, and status information. The coordination mechanisms may implement quality of service controls to prioritize certain data flows and ensure timely delivery of time-sensitive information.

In some cases, step 258 may incorporate advanced message queuing and routing algorithms that can optimize data flow paths based on network conditions and system priorities. These algorithms may implement intelligent buffering strategies that can temporarily store data during network interruptions and resume transmission when connectivity is restored. The messaging protocols may also include data compression and deduplication techniques to minimize bandwidth usage and improve transmission efficiency. Additionally, the coordination system may implement distributed consensus mechanisms that ensure data consistency across multiple system components, preventing conflicts and maintaining system coherence. This robust communication framework may enable seamless operation of distributed robotic systems even in challenging network environments.

Step 260 may involve updating models through standalone learning module without operational disruption. This step may enable continuous system improvement while maintaining uninterrupted robotic operations. The standalone learning module may process accumulated operational data to generate improved models and algorithms, which can then be deployed to active systems through controlled update procedures. The update process may implement validation and testing mechanisms to ensure that new models perform better than existing ones before deployment.

In some aspects, the model updating process in step 260 may incorporate shadow testing and canary deployment strategies to minimize the risk of performance degradation during updates. Shadow testing may involve running new models in parallel with existing ones, comparing their performance on live data without affecting actual operations. Canary deployment may involve gradually rolling out updates to a subset of systems, monitoring their performance before full deployment. The standalone learning module may also implement version control and rollback capabilities, allowing the system to revert to previous model versions if issues are detected. Additionally, the update process may include automated performance validation that can detect and prevent the deployment of models that do not meet predefined quality thresholds. This comprehensive update framework may enable continuous system evolution while maintaining operational stability and reliability.

In some aspects, the method 250 may also include additional steps or variations to enhance its functionality and robustness. For example, the method may incorporate network optimization steps to improve communication efficiency between edge and cloud components. The perception pipeline establishment may be expanded to include multi-sensor fusion capabilities for enhanced environmental understanding. The quality control implementation may include adaptive threshold adjustment mechanisms that respond to changing operational conditions. Additionally, the method may include system monitoring and diagnostics steps to provide real-time visibility into system performance and health. These variations may enhance the effectiveness of the dual-environment processing architecture, enabling more reliable and efficient robotic operations across diverse applications and environments.

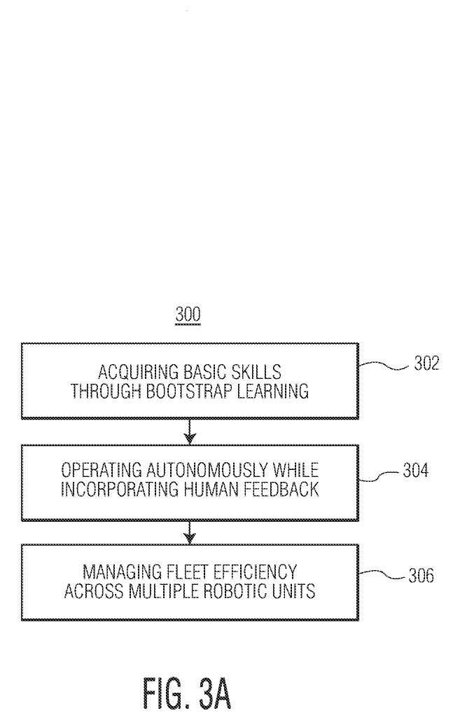

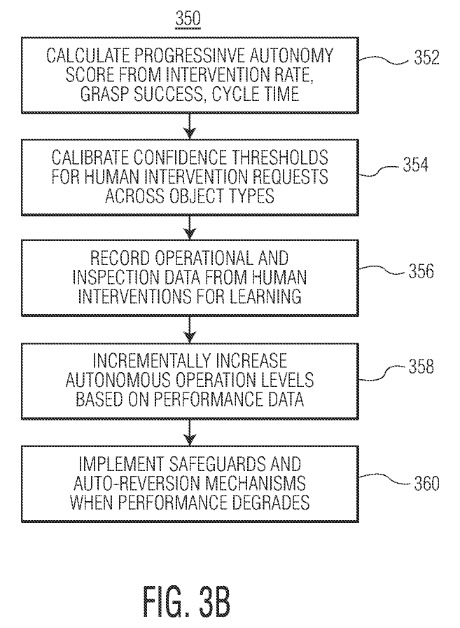

Referring to FIG. 3A, the method 300 for a staged learning process for robotic systems is illustrated. The method 300 may comprise steps that facilitate the progression of robotic learning and operation. The method 300 in FIG. 3A may include step 302 for acquiring basic skills through bootstrap learning, step 304 for operating autonomously while incorporating human feedback, and step 306 for managing fleet efficiency across multiple robotic units.

The method 300 may begin with step 302, which involves acquiring basic skills through bootstrap learning. This initial phase may establish foundational capabilities for the robotic system. Bootstrap learning may involve a human operator demonstrating basic tasks to the robotic system through a remote interface, such as the human-machine interface 108. The robotic system may observe and replicate these tasks, thereby acquiring basic skills. In some cases, the bootstrap learning may be facilitated by a multi-agent collaboration system, which may manage and coordinate tasks across multiple robotic platforms.

In some aspects, the bootstrap learning process may incorporate imitation learning techniques to enhance the robotic system's ability to acquire skills from human demonstrations. These techniques may allow the robotic system to not only replicate the demonstrated actions but also infer the underlying intent and generalize the learned skills to similar but novel situations. The system may utilize advanced computer vision algorithms to analyze the human operator's movements and gestures, extracting features and translating them into a format that can be executed by the robotic system. Additionally, the bootstrap learning phase may include interactive learning components, where the robotic system may request clarification or additional demonstrations from the human operator when faced with ambiguous or complex tasks. This interactive approach may enable the system to refine its understanding of the task requirements and improve its performance through iterative learning cycles.

Following the acquisition of basic skills, the method 300 may proceed to step 304, which entails operating autonomously while incorporating human feedback. This step may allow the robotic system to function independently while still benefiting from human input to refine its operations. The human feedback may be provided through the human-machine interface 108 and may include corrective input or suggestions for improvement. The robotic system may incorporate this feedback into its operations, refining its skills and improving its performance over time.

In some cases, the autonomous operation phase may incorporate adaptive learning algorithms that allow the robotic system to dynamically adjust its behavior based on the received human feedback. These algorithms may analyze patterns in the feedback to identify recurring issues or areas for improvement, enabling the system to proactively modify its operations without constant human intervention. The robotic system may also implement a confidence scoring mechanism, where it assesses its own performance and certainty in executing tasks. When the confidence score falls below a certain threshold, the system may automatically request human input or guidance, ensuring a balance between autonomous operation and human oversight. This approach may enhance the system's ability to handle complex or novel situations while maintaining operational efficiency and safety standards.

Step 306 may involve managing fleet efficiency across multiple robotic units. This step may extend the learning and operational capabilities to a broader scale, optimizing performance across a group of robotic systems. The fleet efficiency management may be facilitated by the multi-agent collaboration system, which may include fleet management and inter-robot communication capabilities. The multi-agent collaboration system may coordinate the operations of multiple robotic systems, ensuring that tasks are distributed efficiently and that the robotic systems work together effectively. In some cases, the multi-agent collaboration system may also facilitate the transfer of learned skills between different robotic systems, promoting versatility and scalability in robotic operations.

In some aspects, the multi-agent collaboration system may incorporate advanced scheduling algorithms and resource allocation techniques to optimize the overall performance of the robotic fleet. These algorithms may consider factors such as task urgency, robot capabilities, current workload, and spatial distribution to dynamically assign tasks and balance the workload across the fleet. The system may also implement predictive maintenance strategies, utilizing data from individual robots to anticipate potential issues and schedule maintenance activities proactively, minimizing downtime and maintaining operational efficiency. Additionally, the multi-agent collaboration system may feature adaptive task decomposition capabilities, allowing complex tasks to be broken down into subtasks that can be distributed among multiple robots, leveraging the collective capabilities of the fleet. This collaborative approach may enable the robotic system to tackle more complex and diverse tasks than may be possible with individual robots, enhancing the overall versatility and productivity of the robotic operations.

In some aspects, the method 300 may also include additional steps or variations. For example, the bootstrap learning phase may include additional training sessions or reinforcement learning techniques to enhance the acquisition of basic skills. The autonomous operation phase may incorporate advanced machine learning algorithms or adaptive control techniques to improve the robotic system's ability to learn from human feedback. The fleet efficiency management phase may include predictive scheduling algorithms or resource allocation techniques to optimize the performance of multiple robotic systems. These variations may enhance the effectiveness of the staged learning process, enabling the robotic system to learn and adapt more effectively in various operational contexts.

In the context of meal kit preparation and dish handling in a dynamic commercial kitchen environment, the steps in FIG. 3A may be applied as follows.

In step 302, when acquiring basic skills through bootstrap learning, the robotic arm may acquire foundational skills for meal kit assembly and dish handling. A human chef may demonstrate basic techniques using the tablet device with touch interface and voice recognition. For example, the chef may show how to pick up and orient specific ingredients or kitchenware, demonstrate proper placement techniques for meal kit components, and illustrate the correct sequence of assembly or dishwashing steps. The robotic system may observe these demonstrations through its visual sensors and replicate the actions, learning the basic motions and procedures for the meal preparation or dishwashing process.

In step 304, when operating autonomously while incorporating human feedback, once the robotic arm has acquired basic meal kit assembly or dish handling skills, it may begin to operate autonomously in the kitchen. As it prepares meal kits or handles dishes, it may encounter variations or challenges not covered in the initial training. In such cases, the system may request feedback from human chefs or kitchen staff. For instance, if the robotic arm encounters a new ingredient or dish type, it may pause the operation and send a notification to the chef's tablet. The chef can then provide guidance through voice commands or touch gestures on the 3D model, showing the correct handling and placement of the new item. The robotic system may incorporate this feedback to refine its techniques and adapt to new menu items or kitchenware.

In step 306, when managing fleet efficiency across multiple robotic units, the knowledge and skills acquired by the initial robotic arm may be shared across multiple units in the kitchen. The multi-agent collaboration system may coordinate the operations of several robotic arms, distributing tasks based on each unit's capabilities and current workload. For example, if one robotic arm has become particularly efficient at a specific meal kit assembly step or dishwashing task, it may be assigned that task more frequently across different menu items or dish types. The system may also facilitate the transfer of learned skills, such as improved motion paths for ingredient placement or efficient dish loading techniques, from one robotic arm to another. This collaborative approach may allow the fleet of robotic arms to continuously improve their performance, reducing preparation times and maintaining consistent quality across various meal kits and dishwashing operations.

Referring to FIG. 3B, the method 350 for progressive autonomy in robotic systems is illustrated. The method 350 may comprise steps that facilitate the gradual increase of autonomous operation capabilities while maintaining safety and performance standards. The method 350 in FIG. 3B may include step 352 for calculating progressive autonomy score from intervention rate, grasp success, and cycle time, step 354 for calibrating confidence thresholds for human intervention requests across object types, step 356 for recording operational and inspection data from human interventions for learning, step 358 for incrementally increasing autonomous operation levels based on performance data, and step 360 for implementing safeguards and auto-reversion mechanisms when performance degrades.

The method 350 may begin with step 352, which involves calculating progressive autonomy score from intervention rate, grasp success, and cycle time. This initial assessment phase may establish baseline performance metrics for the robotic system. The progressive autonomy score may serve as a quantitative measure of the system's readiness to operate with reduced human supervision. The calculation may incorporate multiple performance indicators, including the frequency of human interventions during task execution, the success rate of grasping operations, and the efficiency of task completion cycles. This comprehensive scoring approach may provide a holistic view of the robotic system's capabilities and readiness for increased autonomy.

In some aspects, the progressive autonomy scoring process may incorporate weighted algorithms that adjust the relative importance of different performance metrics based on the operational context and safety requirements. The intervention rate component may track both the frequency and severity of human interventions, distinguishing between minor corrections and operational failures. The grasp success metric may evaluate not only the binary success or failure of grasping operations but also the quality and precision of object manipulation. The cycle time analysis may consider both the speed of task completion and the consistency of performance across multiple operational cycles. Additionally, the scoring system may implement temporal weighting mechanisms that give greater emphasis to recent performance data while still considering historical trends, enabling the system to adapt to improving or degrading performance patterns over time.

Following the autonomy score calculation, the method 350 may proceed to step 354, which entails calibrating confidence thresholds for human intervention requests across object types. This step may customize the system's decision-making parameters based on the specific characteristics and handling requirements of different objects. The confidence thresholds may determine when the robotic system should request human assistance or proceed with autonomous operation. Different object types may require different threshold settings based on their fragility, complexity, or safety implications. This calibration process may enhance the system's ability to make appropriate decisions about when to seek human guidance.

In some cases, the confidence threshold calibration may incorporate machine learning algorithms that analyze historical performance data to optimize threshold settings for different object categories. The system may utilize clustering techniques to group objects with similar handling characteristics, enabling more efficient threshold management across diverse operational scenarios. The calibration process may also consider environmental factors such as lighting conditions, workspace clutter, or time constraints that may affect the system's confidence in successful task execution. Additionally, the threshold calibration may implement adaptive mechanisms that automatically adjust confidence levels based on the system's recent performance with specific object types, enabling continuous refinement of decision-making parameters without requiring manual intervention.

The method 350 may then advance to step 356, which involves recording operational and inspection data from human interventions for learning. This data collection phase may capture detailed information about the circumstances and outcomes of human interventions in the robotic operations. The recorded data may include the specific conditions that triggered the intervention request, the actions taken by the human operator, and the results of the intervention. This comprehensive data collection may enable the system to learn from human expertise and improve its autonomous capabilities over time.

In some aspects, the data recording process may incorporate multi-modal data capture techniques that document not only the operational parameters but also the contextual information surrounding each intervention. The system may record visual data showing the workspace conditions, force sensor readings indicating the physical interactions, and temporal data tracking the sequence of events leading to the intervention. The inspection data may include quality assessments, safety evaluations, and performance metrics that provide insights into the effectiveness of both autonomous operations and human interventions. Additionally, the recording system may implement structured data formats and metadata tagging that facilitate efficient analysis and pattern recognition in the accumulated intervention data, enabling more effective learning from human expertise.

Step 358 of the method 350 may involve incrementally increasing autonomous operation levels based on performance data. This gradual progression approach may allow the robotic system to expand its autonomous capabilities while maintaining safety and performance standards. The incremental increases may be based on demonstrated improvements in the progressive autonomy score and successful operation within the calibrated confidence thresholds. This measured approach may reduce the risk of operational failures while enabling the system to achieve higher levels of independence over time.

In some cases, the incremental autonomy increase process may implement staged progression protocols that define specific milestones and requirements for advancing to higher autonomy levels. The system may utilize statistical analysis techniques to validate performance improvements and ensure that increases in autonomy are supported by consistent and reliable performance data. The progression may also incorporate safety validation procedures that verify the system's ability to handle edge cases and unexpected scenarios at each autonomy level. Additionally, the incremental increase process may include rollback mechanisms that can temporarily reduce autonomy levels if performance degrades, ensuring that the system maintains operational reliability throughout the progression process.

Step 360 may involve implementing safeguards and auto-reversion mechanisms when performance degrades. This safety-focused step may ensure that the robotic system can respond appropriately to declining performance or unexpected operational challenges. The safeguards may include automated monitoring systems that continuously assess performance metrics and trigger protective responses when predetermined thresholds are exceeded. The auto-reversion mechanisms may automatically reduce the system's autonomy level or request human intervention when performance degradation is detected, maintaining operational safety and reliability.

In some aspects, the safeguard implementation may incorporate predictive analytics that can identify potential performance degradation before it becomes problematic. These predictive mechanisms may analyze trends in performance metrics, environmental conditions, and operational parameters to anticipate situations that may require intervention or autonomy reduction. The auto-reversion system may implement graduated response protocols that provide multiple levels of intervention, from minor adjustments to complete handover to human control, depending on the severity of the detected issues. Additionally, the safeguard mechanisms may include diagnostic capabilities that can identify the root causes of performance degradation, enabling targeted corrective actions and preventing recurring issues.

In some aspects, the method 350 may also include additional steps or variations to enhance its effectiveness and robustness. For example, the autonomy scoring phase may incorporate additional performance metrics such as energy efficiency or resource utilization. The confidence threshold calibration may include dynamic adjustment mechanisms that respond to changing operational conditions. The data recording phase may incorporate real-time analysis capabilities that provide immediate feedback on intervention effectiveness. The incremental autonomy increase phase may include simulation-based validation that tests higher autonomy levels in virtual environments before deployment. The safeguard implementation may include predictive maintenance capabilities that anticipate and prevent performance degradation. These variations may enhance the effectiveness of the progressive autonomy approach, enabling more reliable and efficient advancement of robotic capabilities.

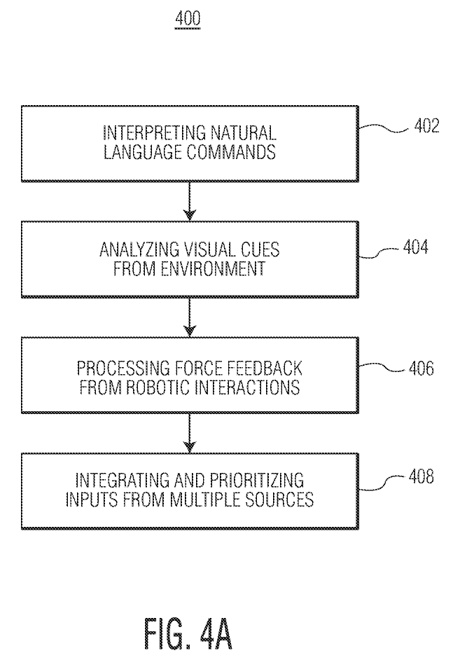

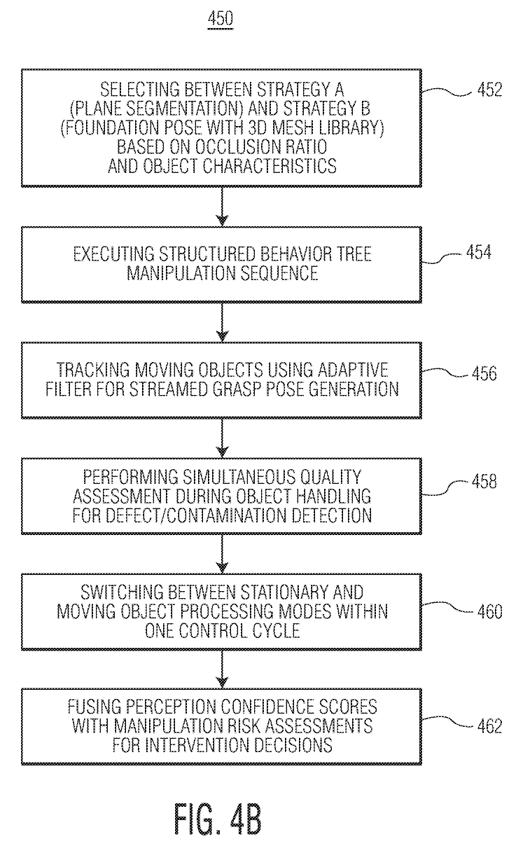

Referring to FIG. 4A, the method 400 for multimodal input processing is illustrated. The method 400 may comprise a series of steps for interpreting natural language commands, analyzing visual cues, processing force feedback, and integrating inputs from multiple sources. The method 400 in FIG. 4A includes step 402 for interpreting natural language commands, step 404 for analyzing visual cues from the environment, step 406 for processing force feedback from robotic interactions, and step 408 for integrating and prioritizing inputs from multiple sources.

The method 400 may begin with step 402, which involves interpreting natural language commands. This step may utilize large language models to analyze spoken or written instructions from a human operator or other input sources. The natural language commands may include, but are not limited to, instructions for task execution, feedback for skill refinement, or queries for information retrieval. The interpretation of natural language commands may enable intuitive and flexible interaction with the robotic systems, reducing the need for technical expertise or complex control interfaces.

In some aspects, the natural language interpretation capabilities of the system may extend beyond simple command processing to include context-aware understanding and intent recognition. The large language models employed in this step may be fine-tuned on domain-specific data, allowing them to comprehend industry-specific terminology and jargon commonly used in the operational environment. This specialized understanding may enable more precise and efficient communication between human operators and robotic systems. Additionally, the system may incorporate sentiment analysis to gauge the urgency or emotional context of the commands, potentially adjusting its response priority or execution style accordingly. The natural language processing module may also feature multilingual support, facilitating seamless interaction with operators from diverse linguistic backgrounds and enhancing the system's global applicability.

Following the interpretation of natural language commands, the method 400 may proceed to step 404, which may entail analyzing visual cues from the environment. This step may involve processing visual data from cameras or other imaging devices to recognize objects, gestures, or other visual elements that are relevant to the robotic tasks. The visual cues may provide contextual information that enhances the understanding of the operational environment and task requirements. In some cases, the visual cues may also include visual feedback from the human operator, such as gestures or pointing actions, which may guide the robotic movements or task execution.

In some aspects, the visual cue analysis may incorporate advanced computer vision techniques, such as deep learning-based object detection and semantic segmentation. These techniques may enable the system to identify and classify multiple objects in complex scenes, even in challenging lighting conditions or partially occluded environments. The system may also utilize motion tracking algorithms to analyze dynamic elements in the environment, such as moving objects or human gestures. This capability may allow the robotic system to adapt its behavior in real-time to changes in its surroundings. Additionally, the visual processing module may include 3D reconstruction algorithms that combine data from multiple cameras or depth sensors to create a comprehensive spatial understanding of the operational environment. This 3D representation may enhance the system's ability to plan and execute tasks that require precise spatial awareness, such as navigating cluttered spaces or manipulating objects with complex geometries.

Step 406 involves processing force feedback from robotic interactions. This step may involve analyzing data from force sensors or haptic devices to adjust the robotic movements or responses based on the force exerted by or on the robot. The force feedback may provide haptic/tactile information that enhances the precision and responsiveness of the robotic systems. In some cases, the force feedback may also include haptic feedback from the human operator, such as pressure or vibration signals, which may provide additional input for skill refinement or task execution.

In some aspects, the force feedback processing may incorporate advanced machine learning algorithms to enhance the system's ability to interpret and respond to complex force patterns. These algorithms may enable the robotic system to learn from past interactions and develop more nuanced responses to various force inputs. For example, the system may utilize reinforcement learning techniques to optimize its force-based responses over time, adapting to different materials, object weights, or environmental conditions. Additionally, the force feedback processing may integrate with other sensory inputs, such as visual data or positional information, to create a more comprehensive understanding of the interaction context. This multi-modal integration may allow the robotic system to make more informed decisions about how to adjust its movements or grip strength in real-time, potentially improving task performance and reducing the risk of damage to objects or the environment.

Step 408 may involve integrating and prioritizing inputs from multiple sources. This step may combine the interpreted natural language commands, the analyzed visual cues, and the processed force feedback to create a comprehensive input dataset for controlling the robotic systems. The integration of inputs may enhance the system's understanding of the operational context and task requirements, enabling more accurate and efficient task execution. The prioritization of inputs may be based on predefined criteria, such as the relevance, urgency, or reliability of the inputs. This prioritization may ensure that inputs are considered in the decision-making process, enhancing the system's responsiveness and effectiveness.

In some aspects, the integration and prioritization process may incorporate adaptive weighting mechanisms that dynamically adjust the importance of different input sources based on the current task context and historical performance data. For example, the system may learn over time that visual cues are more reliable than force feedback for certain types of assembly tasks, and adjust the weighting accordingly. The system may also employ conflict resolution algorithms to handle cases where different input sources provide contradictory information. These algorithms may consider factors such as input source reliability, temporal relevance, and consistency with previously learned patterns to resolve conflicts and make improved (e.g. optimal) decisions. Additionally, the system may implement a feedback loop that continuously evaluates the effectiveness of its integration and prioritization strategies, allowing it to refine and optimize these processes over time. This adaptive approach may enable the robotic system to handle increasingly complex and diverse input scenarios, enhancing its versatility and robustness across a wide range of operational contexts.

In some aspects, the method 400 may also include additional steps or variations. For example, the interpretation of natural language commands may include additional processing steps, such as semantic analysis or sentiment analysis, to enhance the understanding of the commands. The analysis of visual cues may incorporate advanced computer vision techniques, such as object recognition or scene understanding, to improve the recognition of visual elements. The processing of force feedback may include additional filtering or calibration steps to enhance the accuracy of the force measurements. The integration and prioritization of inputs may also include additional decision-making algorithms or machine learning techniques to optimize the selection and combination of inputs. These variations may enhance the effectiveness of the multimodal input processing, enabling the system to handle complex interactions and dynamic environments more effectively.

In the context of meal kit preparation and dish handling in a dynamic commercial kitchen environment, the steps in FIG. 4A may be applied as follows.

Step 402, interpreting natural language commands, may involve processing voice instructions from human chefs or kitchen staff. For instance, when a new menu item is introduced, a chef may provide verbal instructions such as "Adjust portioning for the new salad ingredient" or "Increase stirring speed for sauce X." The system may interpret these commands, understanding the context of the food preparation process and the specific actions that may be needed.

In step 404, analyzing visual cues from the environment, the robotic system may use cameras to observe the kitchen area. It may identify new ingredients, recognize changes in dish presentation, or detect potential obstacles. For example, if a new type of vegetable is introduced, the visual analysis may help the system understand its shape, color, and optimal cutting technique.

Step 406, processing force feedback from robotic interactions, may be beneficial in the food preparation and dish handling process. As the robotic arm handles delicate ingredients or fragile dishware, force sensors may provide data on the pressure applied during chopping, mixing, or plate handling tasks. This feedback may help the system adjust its actions to prevent damage to ingredients or ensure proper plating.

In step 408, integrating and prioritizing inputs from multiple sources, the system may combine the gathered information to make decisions. For instance, if a voice command suggests increasing mixing speed for a batter, but the force feedback indicates resistance, the system may prioritize the force feedback to prevent overmixing. Similarly, if visual cues show a misaligned garnish, this information may take precedence over a pre-programmed plating sequence.

This multimodal input processing may allow the robotic system to adapt to the dynamic kitchen environment, handling new recipes and unforeseen challenges with increased flexibility and efficiency. The integration of various input sources may enable more nuanced and context-aware decision-making, potentially improving the overall quality and speed of the meal preparation and dish handling process.

Referring to FIG. 4B, the method 450 for robotic manipulation and quality control is illustrated. The method 450 may comprise a series of steps for executing structured manipulation sequences, tracking moving objects, performing quality assessments, and making intervention decisions based on perception confidence and manipulation risk factors. The method 450 in FIG. 4B includes step 452 for selecting between strategy A (plane segmentation) and strategy B (foundation pose with 3D mesh library) based on occlusion ratio and object characteristics, step 454 for executing structured behavior tree manipulation sequence, step 456 for tracking moving objects using adaptive filter for streamed grasp pose generation, step 458 for performing simultaneous quality assessment during object handling for defect/contamination detection, step 460 for switching between stationary and moving object processing modes within one control cycle, and step 462 for fusing perception confidence scores with manipulation risk assessments for intervention decisions.

The method 450 may begin with step 452, which involves selecting between strategy A (plane segmentation) and strategy B (foundation pose with 3D mesh library) based on occlusion ratio and object characteristics. This initial decision-making step may enable the system to choose the appropriate manipulation approach based on the current environmental conditions and object properties. Strategy A may utilize plane segmentation techniques that analyze flat surfaces and geometric relationships to determine grasping points, while strategy B may employ a foundation pose approach that leverages a comprehensive 3D mesh library containing detailed object models. The selection criteria may include factors such as the degree of object occlusion, surface complexity, lighting conditions, and the availability of matching models in the 3D mesh library.

In some aspects, the strategy selection process may incorporate machine learning algorithms that analyze historical performance data to optimize the choice between plane segmentation and foundation pose approaches. The system may maintain performance metrics for each strategy across different object types and environmental conditions, enabling data-driven decision-making that improves over time. The occlusion ratio assessment may utilize advanced computer vision techniques to quantify the percentage of object visibility and determine the reliability of visual features available for manipulation planning. Additionally, the object characteristics analysis may include material property assessment, surface texture evaluation, and geometric complexity scoring to ensure that the selected strategy aligns with the specific requirements of each manipulation task.

Following the strategy selection, the method 450 may proceed to step 454, which entails executing structured behavior tree manipulation sequence. This step may implement a hierarchical control framework that organizes complex manipulation tasks into manageable, sequential operations. The behavior tree structure may provide a systematic approach to task execution, incorporating conditional logic, parallel processing capabilities, and error handling mechanisms. The structured sequence may include sub-tasks such as approach planning, grasp execution, object manipulation, and placement operations, each with specific success criteria and fallback procedures.

In some aspects, the behavior tree execution may incorporate adaptive sequencing capabilities that allow for dynamic modification of the manipulation sequence based on real-time feedback and environmental changes. The system may utilize state machines and decision nodes within the behavior tree to handle unexpected situations, such as object displacement or environmental obstacles. The structured approach may also include timing constraints and synchronization mechanisms that ensure coordinated operation when multiple robotic systems are involved in collaborative manipulation tasks. Additionally, the behavior tree framework may implement logging and monitoring capabilities that track the execution of each sequence step, providing data for performance analysis and continuous improvement of manipulation strategies.

Step 456 involves tracking moving objects using adaptive filter for streamed grasp pose generation. This step may enable the system to handle dynamic scenarios where target objects are in motion during the manipulation process. The adaptive filtering approach may utilize predictive algorithms to estimate object trajectories and generate real-time grasp pose updates that account for object movement. The streaming capability may provide continuous pose generation, allowing the robotic system to adjust its manipulation strategy in real-time as objects move through the workspace.

In some aspects, the moving object tracking may incorporate advanced filtering techniques such as Kalman filters that can handle non-linear motion patterns and account for measurement uncertainties. The adaptive nature of the filtering system may allow it to adjust its parameters based on the observed motion characteristics of different object types, improving tracking accuracy for various scenarios. The streamed grasp pose generation may utilize predictive modeling to anticipate future object positions, enabling the robotic system to plan interception trajectories and execute successful grasps on moving targets. Additionally, the tracking system may implement multi-sensor fusion capabilities that combine visual tracking with other sensing modalities, such as radar or lidar, to maintain robust object tracking even in challenging environmental conditions.

Step 458 may involve performing simultaneous quality assessment during object handling for defect/contamination detection. This step may enable real-time quality control that occurs concurrently with manipulation operations, eliminating the need for separate inspection phases and improving overall system efficiency. The quality assessment may utilize computer vision algorithms trained on domain-specific datasets to identify various types of defects, contamination, or quality issues. The simultaneous processing capability may allow the system to make immediate decisions about object handling based on quality assessments, potentially redirecting defective items to appropriate disposal or rework processes.

In some aspects, the simultaneous quality assessment may incorporate multi-spectral imaging techniques that can detect quality issues not visible to standard RGB cameras, such as internal defects or chemical contamination. The system may utilize machine learning models specifically trained for quality assessment in the operational domain, enabling accurate detection of subtle quality variations that may affect product acceptability. The real-time processing capability may implement edge computing architectures that provide low-latency quality assessments without compromising manipulation performance. Additionally, the quality assessment system may include adaptive threshold mechanisms that can adjust detection sensitivity based on product specifications, environmental conditions, or quality standards specific to different operational contexts.

The method 450 may then advance to step 460, which involves switching between stationary and moving object processing modes within one control cycle. This step may provide the system with the flexibility to handle mixed scenarios where both stationary and moving objects are present in the workspace simultaneously. The mode switching capability may enable seamless transitions between different processing algorithms and control strategies optimized for each object type. The single control cycle implementation may ensure that mode transitions occur without disrupting the overall manipulation workflow or introducing significant latency.

In some cases, the mode switching process may incorporate intelligent scheduling algorithms that optimize the allocation of computational resources between stationary and moving object processing tasks. The system may utilize priority-based scheduling that considers factors such as task urgency, object proximity, and manipulation complexity to determine the optimal processing sequence. The seamless switching capability may implement state preservation mechanisms that maintain relevant context information during mode transitions, ensuring continuity in object tracking and manipulation planning. Additionally, the unified control cycle approach may include synchronization mechanisms that coordinate the processing of multiple objects with different motion characteristics, enabling efficient handling of complex multi-object scenarios.

Step 462 may involve fusing perception confidence scores with manipulation risk assessments for intervention decisions. This final step may integrate quantitative measures of perception reliability with risk analysis to determine when human intervention may be beneficial or necessary. The perception confidence scores may reflect the system's certainty in its object recognition, pose estimation, and quality assessment capabilities. The manipulation risk assessments may evaluate factors such as object fragility, environmental hazards, and potential consequences of manipulation errors. The fusion process may combine these inputs to generate intervention recommendations that balance autonomous operation with safety and quality requirements.

In some aspects, the confidence score fusion may utilize advanced decision-making frameworks such as fuzzy logic or Bayesian inference to handle uncertainty and conflicting information from multiple sources. The risk assessment component may incorporate predictive modeling that evaluates potential failure modes and their associated consequences, enabling proactive intervention decisions. The intervention decision system may implement graduated response mechanisms that provide multiple levels of human involvement, from simple alerts to complete handover of control, depending on the assessed risk level. Additionally, the fusion process may include learning capabilities that refine intervention thresholds based on historical performance data and operator feedback, continuously improving the balance between autonomous operation and human oversight.

In some aspects, the method 450 may also include additional steps or variations to enhance its functionality and robustness. For example, the strategy selection phase may incorporate environmental condition monitoring that influences the choice between manipulation approaches. The behavior tree execution may include parallel processing capabilities that enable simultaneous execution of multiple manipulation sequences. The moving object tracking may incorporate predictive collision avoidance that prevents interference between the robotic system and moving objects. The quality assessment phase may include adaptive learning mechanisms that improve detection accuracy based on operational feedback. The mode switching capability may include performance optimization algorithms that minimize computational overhead during transitions. The intervention decision process may incorporate operator preference learning that adapts to individual user requirements and expertise levels. These variations may enhance the effectiveness of the robotic manipulation and quality control process, enabling the system to handle increasingly complex and diverse operational scenarios with improved reliability and efficiency.

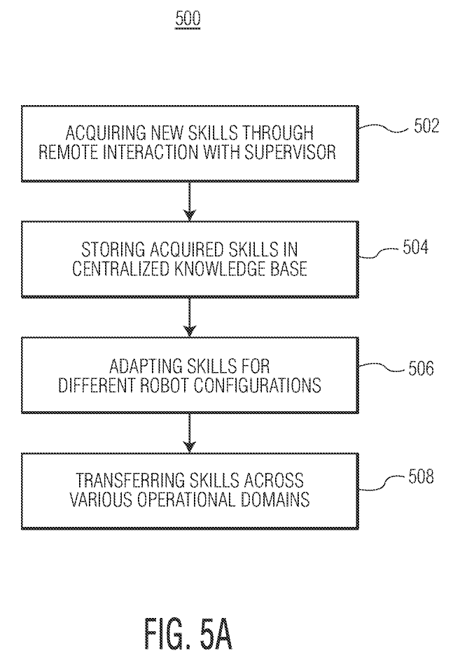

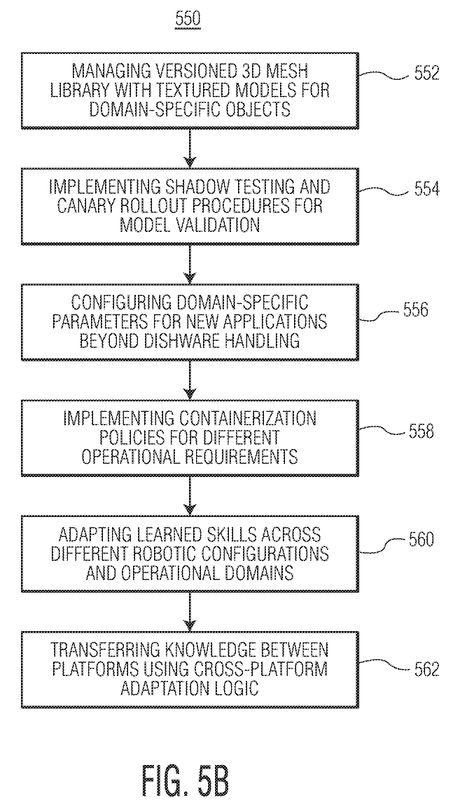

Referring to FIG. 5A, the method 500 for robotic skill acquisition and transfer is illustrated. The method 500 may comprise a sequence of steps for learning, storing, adapting, and transferring skills across robotic systems.

The method 500 in FIG. 5A may include step 502 for acquiring new skills through remote interaction with a supervisor, step 504 for storing acquired skills in a centralized knowledge base, step 506 for adapting skills for different robot configurations, and step 508 for transferring skills across various operational domains.

The method 500 may begin with step 502, which involves acquiring new skills through remote interaction with a supervisor. This step may allow for skill learning without requiring physical presence. The supervisor may be a human operator who demonstrates basic tasks to the robotic system through a remote interface, such as the human-machine interface 108. The robotic system may observe and replicate these tasks, thereby acquiring basic skills. In some cases, the supervisor may provide feedback or corrections during the demonstration, which the robotic system may incorporate into its skill learning process.

In some aspects, the remote skill acquisition process may incorporate advanced machine learning techniques to enhance the robotic system's ability to learn from demonstrations. For example, the system may utilize imitation learning algorithms to extract features from the supervisor's demonstrations and generalize them to similar but novel situations. The robotic system may also employ active learning strategies, prompting the supervisor for additional demonstrations or clarifications when faced with ambiguous or complex tasks. This interactive learning approach may enable the system to refine its understanding of task requirements and improve its performance through iterative learning cycles. Additionally, the remote interaction may be augmented with virtual reality or augmented reality technologies, allowing the supervisor to provide more immersive and detailed demonstrations. These technologies may enhance the fidelity of skill transfer, enabling the robotic system to capture subtle nuances of task execution that may be difficult to convey through traditional remote interfaces.

Following skill acquisition, the method 500 may proceed to step 504, which entails storing acquired skills in a centralized knowledge base. This step may enable efficient management and retrieval of learned capabilities. The centralized knowledge base, which may be represented by the system database 114, may store information about the learned skills, including the specific actions performed, the sequence of actions, and any associated parameters or conditions. This stored information may be used to replicate the learned skills in the future, reducing the need for repeated demonstrations.

In some aspects, the centralized knowledge base may implement advanced data compression and indexing techniques to optimize storage efficiency and retrieval speed. These techniques may allow for efficient storage of large volumes of skill data, including complex motion trajectories, sensor readings, and contextual information. The knowledge base may also incorporate version control mechanisms, enabling the system to track the evolution of skills over time and revert to previous versions if needed. Additionally, the centralized knowledge base may feature a hierarchical structure, organizing skills into categories and subcategories based on their characteristics, complexity, or application domain. This hierarchical organization may facilitate faster skill retrieval and enable the system to identify relationships between different skills, potentially leading to the discovery of new, composite skills through the combination of existing ones.

The method 500 may then advance to step 506, which involves adapting skills for different robot configurations. This step may allow the learned skills to be applied across various robotic platforms with different physical characteristics. The adaptation process may involve adjusting the specific actions or parameters of the learned skills based on the physical characteristics of the target robotic platform. For example, a skill learned on a robotic arm with a certain range of motion may be adapted for a robotic arm with a different range of motion by adjusting the movement angles or distances.

Additionally, the adaptation process may consider the computational capabilities and sensor arrays of different robotic platforms. For instance, if a skill involves complex visual processing tasks, the adaptation may modify the algorithms to suit the processing power and camera specifications of the target robot. This ensures that the skill is not only physically executable but also optimized for the specific hardware and software environment of each robot. This level of customization may enhance the efficiency and effectiveness of the robotic systems, enabling them to perform tasks with higher precision and reliability across diverse operational settings.

Step 508 may involve transferring skills across various operational domains. This step may enable the application of learned capabilities in different contexts or environments. The transfer process may involve mapping the learned skills to new tasks or scenarios, allowing the robotic system to perform similar tasks in different operational domains. For example, a skill learned for assembling a specific product in a manufacturing environment may be transferred to a similar assembly task in a different product line or industry.

In some cases, the skill transfer process may incorporate domain adaptation techniques to bridge the gap between different operational contexts. These techniques may involve identifying and leveraging common features or underlying principles across domains, allowing the robotic system to generalize its learned skills more effectively. The system may utilize transfer learning algorithms to fine-tune the transferred skills for the new domain, adjusting parameters or action sequences to account for domain-specific variations. Additionally, the skill transfer process may include a validation and refinement phase, where the transferred skills are tested and iteratively improved in the new operational domain. This may involve collecting performance data, analyzing discrepancies between expected and actual outcomes, and making adjustments to optimize the skill's effectiveness in the new context. The ability to transfer and adapt skills across diverse operational domains may significantly enhance the versatility and scalability of robotic systems, potentially reducing the time and resources for deployment in new environments or industries.

In some aspects, the method 500 may also include additional steps or variations. For example, the skill acquisition phase may include additional training sessions or reinforcement learning techniques to enhance the acquisition of basic skills. The skill storage phase may incorporate data compression or encryption techniques to optimize storage efficiency and security. The skill adaptation phase may include machine learning algorithms or simulation techniques to improve the accuracy and effectiveness of skill adaptation. The skill transfer phase may incorporate task mapping algorithms or domain adaptation techniques to enhance the versatility and applicability of the transferred skills. These variations may enhance the effectiveness of the robotic skill acquisition and transfer process, enabling the robotic system to learn and adapt more effectively in various operational contexts.

In the context of meal kit preparation and dish handling in a dynamic commercial kitchen environment, the steps in FIG. 5A may be applied as follows.

Step 502, acquiring new skills through remote interaction with a supervisor, may involve a human chef demonstrating a new food preparation technique for a novel menu item. For instance, the chef may use a virtual reality interface to show the robotic arm how to handle and assemble ingredients for a complex salad or how to properly load and unload a new type of dishware. The robotic system may observe the chef's movements, force application, and sequence of actions, learning the new skill without requiring the chef's physical presence in the kitchen.

In step 504, storing acquired skills in a centralized knowledge base, the system may save the newly learned food preparation or dish handling technique in the system database 114. This stored information may include the precise movement patterns, force profiles, and visual recognition data needed to identify and handle the new ingredients or dishware. The knowledge base may also record contextual information, such as the kitchen conditions under which the skill was demonstrated and any specific food safety precautions or quality control checks associated with the new preparation process.

Step 506, adapting skills for different robot configurations, may involve modifying the newly acquired food preparation or dish handling technique for use by robotic arms with different specifications. For example, if the skill was initially demonstrated on a robotic arm with a certain reach and grip strength, the system may adapt it for use on a robotic arm with different capabilities, adjusting the movement patterns to maintain the quality of food preparation or ensure safe handling of dishes while taking advantage of each robot's unique features.

In step 508, transferring skills across various operational domains, the system may apply the food preparation or dish handling technique to similar tasks in different kitchen setups or even different culinary styles. For instance, the precise chopping and arrangement skills learned for a particular salad preparation may be transferred to the assembly of other dishes that require similar dexterity and presentation. The system may adjust parameters such as cutting force, mixing speed, or plating precision to account for differences in ingredients, cooking methods, and presentation styles, while maintaining the core principles of the culinary skill.

This skill acquisition and transfer process may allow the robotic system to rapidly adapt to new menu items, dietary requirements, and kitchen equipment, enhancing its versatility and efficiency across various food preparation and dish handling tasks in the dynamic commercial kitchen environment.

Referring to FIG. 5B, the method 550 for managing versioned mesh libraries and skill adaptation is illustrated. The method 550 may comprise a sequence of steps for managing three-dimensional object models, validating system updates, configuring domain-specific applications, implementing operational policies, adapting learned capabilities, and transferring knowledge across platforms.

The method 550 in FIG. 5B may include step 552 for managing versioned 3D mesh library with textured models for domain-specific objects, step 554 for implementing shadow testing and canary rollout procedures for model validation, step 556 for configuring domain-specific parameters for new applications beyond dishware handling, step 558 for implementing containerization policies for different operational requirements, step 560 for adapting learned skills across different robotic configurations and operational domains, and step 562 for transferring knowledge between platforms using cross-platform adaptation logic.

The method 550 may begin with step 552, which involves managing versioned 3D mesh library with textured models for domain-specific objects. This step may establish a comprehensive repository of three-dimensional object representations that can be utilized across various robotic applications. The versioned mesh library may contain detailed geometric models with surface textures that enable accurate object recognition and manipulation planning. The management system may track different versions of object models, allowing for updates and improvements while maintaining backward compatibility with existing robotic systems.

In some aspects, the versioned mesh library management may incorporate automated model generation techniques that can create three-dimensional representations from multiple camera angles or depth sensor data. The system may utilize photogrammetry or structured light scanning to capture detailed surface textures and geometric features of objects. The versioning system may implement branching and merging capabilities similar to software version control, enabling parallel development of object models for different applications or environments. Additionally, the mesh library may include metadata associated with each object model, such as material properties, handling constraints, and manipulation strategies that have been validated through operational experience. This comprehensive approach to model management may enable more accurate and reliable robotic interactions with diverse objects across various operational contexts.

Following the mesh library management, the method 550 may proceed to step 554, which entails implementing shadow testing and canary rollout procedures for model validation. This step may establish robust validation mechanisms that ensure new models or system updates perform reliably before full deployment. Shadow testing may involve running new models in parallel with existing ones, comparing their performance on live data without affecting actual operations. Canary rollout procedures may enable gradual deployment of updates to a subset of systems, monitoring their performance before broader implementation.

In some cases, the shadow testing implementation may incorporate statistical analysis techniques to quantify performance differences between new and existing models. The system may utilize A/B testing methodologies to evaluate model effectiveness across different operational scenarios and object types. The canary rollout procedures may include automated rollback mechanisms that can quickly revert to previous model versions if performance degradation is detected. Additionally, the validation process may incorporate user acceptance testing components, allowing human operators to evaluate new models in controlled environments before production deployment. This comprehensive validation framework may minimize the risk of operational disruptions while enabling continuous improvement of robotic capabilities.

The method 550 may then advance to step 556, which involves configuring domain-specific parameters for new applications beyond dishware handling. This step may enable the adaptation of the robotic system to diverse operational contexts and industries. The configuration process may involve adjusting recognition algorithms, manipulation strategies, and quality assessment criteria to suit specific application requirements. The domain-specific parameters may include object handling protocols, safety constraints, and performance metrics tailored to particular industries or use cases.

In some aspects, the domain configuration process may incorporate machine learning techniques that can automatically optimize parameters based on operational data from new application domains. The system may utilize clustering algorithms to identify common characteristics within specific domains and adjust system behavior accordingly. The configuration framework may include template-based approaches that provide starting points for new domain implementations, reducing the time and expertise needed for system deployment. Additionally, the domain-specific configuration may include regulatory compliance features that ensure robotic operations meet industry-specific standards and safety requirements. This flexible configuration approach may enable rapid deployment of robotic systems across diverse industries while maintaining high performance and safety standards.

Step 558 of the method 550 may involve implementing containerization policies for different operational requirements. This step may establish deployment and management strategies that enable flexible system configuration across various operational environments. Containerization policies may define how robotic software components are packaged, deployed, and managed to ensure consistent operation across different hardware platforms and operational contexts. The policies may include resource allocation strategies, security protocols, and update mechanisms tailored to specific operational requirements.

In some cases, the containerization implementation may incorporate orchestration platforms that can automatically manage the deployment and scaling of robotic software components. The system may utilize container registry services to maintain versioned repositories of software components, enabling efficient distribution and updates across multiple robotic platforms. The containerization policies may include environment-specific configurations that optimize performance for different operational contexts, such as edge computing environments or cloud-based processing systems. Additionally, the containerization framework may implement security isolation mechanisms that protect sensitive operational data and prevent unauthorized access to robotic control systems. This comprehensive containerization approach may enhance system reliability, security, and maintainability across diverse deployment scenarios.

The method 550 may then advance to step 560, which involves adapting learned skills across different robotic configurations and operational domains. This step may enable the application of acquired capabilities across diverse robotic platforms and operational contexts. The adaptation process may involve translating learned behaviors to accommodate different physical characteristics, sensor configurations, and computational capabilities of various robotic systems. The cross-domain adaptation may utilize transfer learning techniques to apply skills learned in one operational context to related but distinct scenarios.

In some aspects, the skill adaptation process may incorporate simulation-based validation that tests adapted skills in virtual environments before deployment to physical systems. The system may utilize reinforcement learning algorithms to fine-tune adapted skills based on performance feedback from new operational contexts. The adaptation framework may include compatibility assessment mechanisms that evaluate whether specific skills can be successfully transferred to target robotic platforms. Additionally, the skill adaptation process may implement performance monitoring capabilities that track the effectiveness of adapted skills and identify opportunities for further optimization. This comprehensive adaptation approach may maximize the utility of learned skills across diverse robotic systems and operational environments.

Step 562 may involve transferring knowledge between platforms using cross-platform adaptation logic. This final step may enable seamless sharing of learned capabilities across different robotic systems and operational environments. The cross-platform transfer process may utilize standardized interfaces and protocols that facilitate knowledge exchange between heterogeneous robotic platforms. The adaptation logic may automatically adjust transferred knowledge to account for platform-specific characteristics and constraints.

In some cases, the cross-platform knowledge transfer may incorporate federated learning techniques that enable collaborative learning across multiple robotic systems without requiring centralized data sharing. The system may utilize semantic mapping approaches that translate knowledge representations between different robotic platforms and software frameworks. The transfer process may include validation mechanisms that verify the successful adaptation of transferred knowledge before deployment to target systems. Additionally, the cross-platform adaptation logic may implement bidirectional knowledge sharing, enabling robotic systems to both contribute to and benefit from shared knowledge repositories. This collaborative knowledge transfer approach may accelerate learning across robotic fleets and enable rapid deployment of proven capabilities to new operational contexts.

In some aspects, the method 550 may also include additional steps or variations to enhance its functionality and robustness. For example, the mesh library management phase may incorporate automated quality assessment mechanisms that validate model accuracy and completeness. The shadow testing implementation may include performance benchmarking capabilities that compare new models against established baselines. The domain configuration phase may incorporate adaptive parameter tuning that optimizes system behavior based on operational feedback. The containerization implementation may include disaster recovery mechanisms that ensure system resilience in challenging operational environments. The skill adaptation phase may incorporate explainable AI techniques that provide insights into adaptation decisions and outcomes. The knowledge transfer phase may include privacy-preserving mechanisms that protect sensitive operational data during cross-platform sharing. These variations may enhance the effectiveness of the versioned mesh library and skill adaptation process, enabling more reliable and efficient robotic operations across diverse applications and environments.

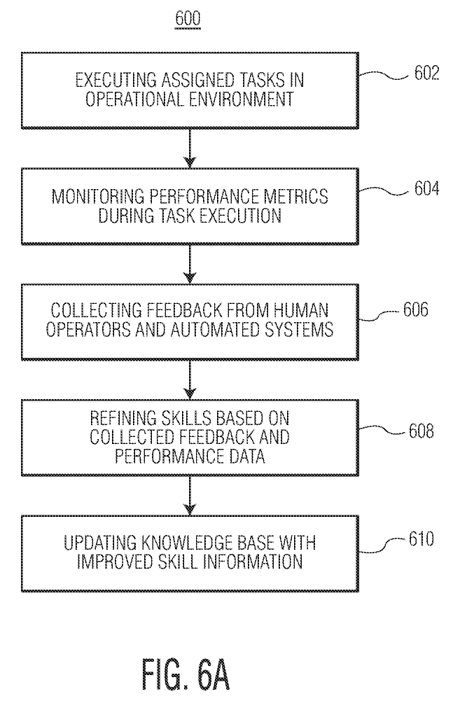

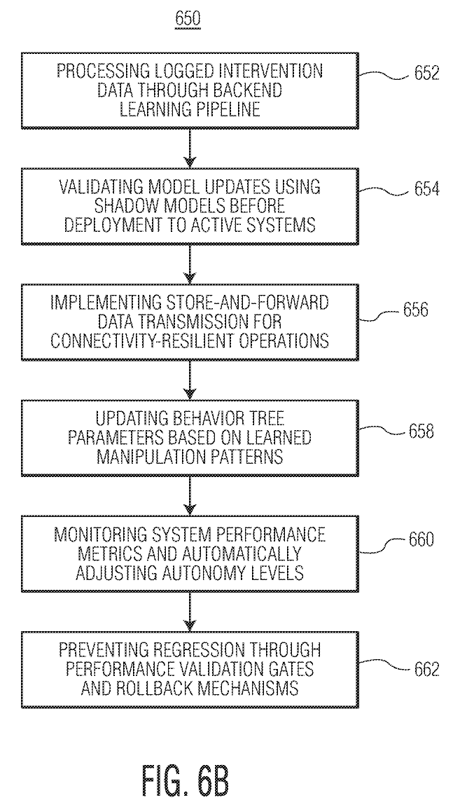

Referring to FIG. 6A, the method 600 for continuous learning and improvement is illustrated. The method 600 may comprise a sequence of steps for enhancing operational efficiency and skill refinement in a dynamic environment.

The method 600 in FIG. 6A comprises step 602 executing assigned tasks in an operational environment, step 604 monitoring performance metrics during task execution, step 606 collecting feedback from human operators and automated systems, step 608 refining skills based on collected feedback and performance data, and 610 updating the knowledge base with improved skill information.

The method 600 may begin with step 602, which involves executing assigned tasks in an operational environment. This step may allow the robotic system to apply its learned skills in real-world scenarios. The tasks may be assigned by a human operator or an automated task management system, and may include a variety of operations such as object manipulation, navigation, or interaction with other robotic systems or human operators.

In some aspects, the execution of assigned tasks in step 602 may involve adaptive task planning and real-time decision-making capabilities. The robotic system may utilize its learned skills in combination with environmental sensing and situational awareness to dynamically adjust its approach to task execution. For instance, in a manufacturing environment, the system may encounter variations in part positioning or unexpected obstacles, requiring it to modify its pre-programmed movements on the fly. The robotic system may also prioritize tasks based on urgency, efficiency, or resource availability, optimizing its workflow in response to changing operational conditions. Additionally, the system may collaborate with other robotic units or human workers, coordinating actions and sharing resources to achieve complex, multi-step objectives. This adaptive execution approach may enhance the robotic system's ability to handle diverse and unpredictable scenarios, improving overall operational flexibility and resilience.

Following task execution, the method 600 may proceed to step 604, which entails monitoring performance metrics during task execution. This step may involve collecting and analyzing data related to the robotic system's performance, such as task completion time, accuracy, efficiency, or safety compliance. The performance metrics may be used to evaluate the effectiveness of the learned skills and identify areas for improvement.

In some cases, the performance monitoring process may incorporate advanced data analytics techniques to provide deeper insights into the robotic system's performance. These techniques may include real-time anomaly detection algorithms that can identify deviations from expected performance patterns, potentially flagging issues before they become problematic. The system may also employ predictive analytics to forecast future performance based on historical data and current trends, allowing for proactive optimization of robotic operations. Additionally, the performance monitoring step may include comparative analysis, benchmarking the robotic system's performance against predefined standards or the performance of other similar systems. This comparative approach may help identify best practices and areas where the system excels or lags behind, providing information for targeted improvements and resource allocation in the continuous learning process.

The method 600 may then advance to step 606, which involves collecting feedback from human operators and automated systems. This step may involve receiving corrective input or suggestions for improvement from human operators, or analyzing diagnostic data from the robotic system or other automated systems. The feedback may provide qualitative insights into the task execution and identify areas for improvement.

In some aspects, the feedback collection process may incorporate multiple channels and modalities to ensure comprehensive input. For instance, the system may utilize natural language processing to interpret verbal feedback from human operators, analyze gesture-based input through computer vision algorithms, or process haptic/tactile feedback from force-sensitive interfaces. The automated systems may provide feedback through various data streams, including sensor readings, error logs, and performance metrics. Additionally, the feedback collection step may include sentiment analysis to gauge the satisfaction levels of human operators and stakeholders. This multi-faceted approach to feedback collection may enable the robotic system to gather a rich dataset of qualitative and quantitative information, providing a nuanced understanding of its performance and potential areas for improvement across different operational aspects and user perspectives.

Step 608 of the method 600 may involve refining skills based on collected feedback and performance data. This step may involve adjusting the robotic system's actions or behaviors based on the feedback and performance data, thereby refining its skills and improving its performance over time. The skill refinement may be facilitated by a continuous learning module, which may analyze the feedback and performance data and update the robotic system's behavior accordingly.

In some cases, the skill refinement process may incorporate advanced machine learning techniques to enhance the robotic system's ability to adapt and improve its performance. These techniques may include reinforcement learning algorithms that allow the system to learn improved (e.g. optimal) strategies through trial and error, adjusting its behavior based on rewards or penalties associated with different actions. The continuous learning module may also employ ensemble learning methods, combining multiple models or algorithms to make more robust and accurate decisions. Additionally, the skill refinement process may include a simulation component, allowing the robotic system to practice and refine its skills in a virtual environment before applying them in real-world scenarios. This simulation-based approach may enable the system to explore a wider range of scenarios and potential outcomes, accelerating the learning process and reducing the risk of errors or inefficiencies in actual operations.

Step 610 may involve updating the knowledge base with improved skill information. This step may involve storing the refined skills and associated performance data in the shareable knowledge base, allowing the improved skills to be accessed and utilized by other robotic systems. The knowledge base update may be facilitated by a shareable knowledge base, which may store and retrieve robotic task execution data upon request.

In some aspects, the knowledge base update process may incorporate version control mechanisms to track the evolution of skills over time. This versioning system may allow the robotic system to maintain a history of skill improvements, enabling rollback to previous versions if needed or comparison of performance across different skill iterations. The shareable knowledge base may also implement advanced indexing and retrieval algorithms to optimize the storage and access of skill information. These algorithms may categorize skills based on various attributes such as task type, operational domain, or performance metrics, facilitating efficient skill retrieval and application. Additionally, the knowledge base update process may include a validation step, where newly refined skills are tested in simulated environments before being made available to other robotic systems. This validation may help ensure the reliability and effectiveness of shared skills, maintaining the overall quality of the knowledge base across multiple robotic platforms and operational contexts.

In some aspects, the method 600 may also include additional steps or variations. For example, the task execution phase may include additional monitoring or control mechanisms to enhance the accuracy or safety of the tasks. The performance monitoring phase may incorporate advanced data analysis techniques or machine learning algorithms to improve the accuracy and comprehensiveness of the performance metrics. The feedback collection phase may include additional communication channels or feedback mechanisms to enhance the quality and relevance of the feedback. The skill refinement phase may incorporate advanced learning algorithms or adaptive control techniques to improve the effectiveness of skill refinement. The knowledge base update phase may include additional data management or security measures to enhance the integrity and accessibility of the stored data. These variations may enhance the effectiveness of the continuous learning and improvement process, enabling the robotic system to adapt and improve more effectively in various operational contexts.

In the context of meal kit preparation and dish handling in a dynamic commercial kitchen environment, the steps in FIG. 6A may be applied as follows.

Step 602, executing assigned tasks in an operational environment, may involve the robotic arm performing food preparation techniques or dish handling procedures it acquired in previous stages. The robotic arm may execute these tasks repeatedly for various menu items or dishware types in the commercial kitchen.

In step 604, monitoring performance metrics during task execution, the system may track metrics such as ingredient portioning accuracy, time taken for each meal kit assembly or dish handling operation, the number of successfully prepared meals or properly handled dishes versus errors, and the overall efficiency of the food preparation or dishwashing process. The system may also monitor the force applied during chopping, mixing, or dish handling to ensure it remains within acceptable limits for different ingredients or kitchenware.

Step 606, collecting feedback from human operators and automated systems, may involve gathering input from chefs, kitchen staff, or quality control personnel who inspect the prepared meal kits or handled dishes. The automated systems may provide feedback through sensors that detect any inconsistencies in ingredient measurements, cooking temperatures, or errors in dish placement. Additionally, customer satisfaction reports or feedback from serving staff may provide insights on the quality and presentation of the prepared meals or the cleanliness of the handled dishes.

In step 608, refining skills based on collected feedback and performance data, the system may adjust its food preparation or dish handling techniques. For instance, if the feedback indicates that certain ingredients are being chopped too coarsely or dishes are being loaded with excessive force, the system may fine-tune its cutting parameters or adjust its handling pressure. If certain menu items or dishware types consistently present challenges, the system may develop item-specific variations of the preparation or handling techniques.

In step 610, updating the knowledge base with improved skill information, the refined food preparation or dish handling techniques may be stored in the shareable knowledge base. This updated skill information may include optimized cutting or mixing profiles, improved visual recognition patterns for different ingredients or dishware designs, and adaptive strategies for handling various menu items or kitchenware types.

Referring to FIG. 6B, the method 650 for processing intervention data and updating system behavior is illustrated. The method 650 may comprise a sequence of steps for analyzing operational data, validating system improvements, and implementing robust update mechanisms in distributed robotic environments.

The method 650 in FIG. 6B may include step 652 for processing logged intervention data through backend learning pipeline, step 654 for validating model updates using shadow models before deployment to active systems, step 656 for implementing store-and-forward data transmission for connectivity-resilient operations, step 658 for updating behavior tree parameters based on learned manipulation patterns, step 660 for monitoring system performance metrics and automatically adjusting autonomy levels, and step 662 for preventing regression through performance validation gates and rollback mechanisms.

The method 650 may begin with step 652, which involves processing logged intervention data through backend learning pipeline. This initial data processing phase may analyze accumulated records of human interventions, system corrections, and operational anomalies to extract meaningful patterns and insights. The backend learning pipeline may utilize data processing techniques to identify recurring issues, successful intervention strategies, and opportunities for system improvement. The logged intervention data may include detailed records of the circumstances that triggered human involvement, the specific actions taken by operators, and the outcomes of these interventions.

In some aspects, the backend learning pipeline may incorporate distributed computing architectures that can handle large volumes of intervention data from multiple robotic systems simultaneously. The processing pipeline may utilize stream processing technologies to analyze data in real-time as it arrives from operational systems, enabling rapid identification of emerging patterns or problematic issues. The system may also employ data mining techniques to discover hidden relationships between different types of interventions and their effectiveness across various operational contexts. Additionally, the backend processing may include data quality assessment mechanisms that validate the completeness and accuracy of logged intervention data, ensuring that the learning process is based on reliable information. This comprehensive data processing approach may enable the system to extract maximum value from operational experiences and translate them into actionable improvements.

Following the data processing, the method 650 may proceed to step 654, which entails validating model updates using shadow models before deployment to active systems. This validation phase may establish rigorous testing procedures that ensure new models or system improvements perform reliably before affecting operational systems. Shadow models may run in parallel with existing production models, processing the same input data and generating predictions or control decisions that can be compared against established baselines. The validation process may evaluate multiple performance criteria, including accuracy, reliability, and computational efficiency.

In some cases, the shadow model validation may incorporate statistical significance testing to quantify the improvement or degradation in performance compared to existing models. The system may utilize A/B testing methodologies that randomly assign tasks to different model versions, enabling controlled comparison of their effectiveness. The validation process may also include stress testing components that evaluate model performance under challenging conditions such as high workload, degraded sensor data, or unusual environmental factors. Additionally, the shadow model validation may implement automated decision criteria that determine when new models are ready for deployment based on predefined performance thresholds and confidence intervals. This rigorous validation framework may minimize the risk of deploying models that could negatively impact operational performance while ensuring that beneficial improvements are identified and implemented efficiently.

The method 650 may then advance to step 656, which involves implementing store-and-forward data transmission for connectivity-resilient operations. This step may establish robust communication mechanisms that enable continued operation and data collection even when network connectivity is intermittent or unreliable. The store-and-forward approach may temporarily cache operational data, intervention records, and system updates locally when network connections are unavailable, then transmit the accumulated information when connectivity is restored. This approach may ensure that valuable operational data is not lost due to network interruptions and that system improvements can continue even in challenging connectivity environments.

In some aspects, the store-and-forward implementation may incorporate intelligent data prioritization mechanisms that determine which information should be transmitted first when connectivity is restored. The system may prioritize certain safety data, system updates, or high-value learning data based on predefined criteria and operational requirements. The data transmission system may also implement compression and deduplication techniques to minimize bandwidth usage and reduce transmission times when connectivity is limited. Additionally, the store-and-forward mechanism may include data integrity verification procedures that ensure transmitted data has not been corrupted during storage or transmission. This resilient communication approach may enable robust operation of distributed robotic systems across diverse network environments while maintaining the continuity of learning and improvement processes.

Step 658 of the method 650 may involve updating behavior tree parameters based on learned manipulation patterns. This step may translate insights gained from intervention data analysis into specific adjustments to the robotic control systems. The behavior tree parameter updates may modify decision thresholds, timing constraints, force limits, or sequence priorities based on patterns identified in successful interventions. The updates may be tailored to specific object types, environmental conditions, or operational contexts to maximize their effectiveness.

In some cases, the behavior tree parameter updating may incorporate machine learning algorithms that can automatically optimize parameter values based on historical performance data and intervention outcomes. The system may utilize genetic algorithms or other optimization techniques to explore parameter spaces and identify configurations that maximize task success rates while minimizing intervention requirements. The parameter updating process may also include sensitivity analysis that evaluates how changes to specific parameters affect overall system performance, enabling targeted adjustments that provide maximum benefit. Additionally, the behavior tree updates may implement hierarchical parameter management that allows for global system-wide adjustments as well as task-specific or object-specific parameter modifications. This flexible parameter updating approach may enable fine-tuned optimization of robotic behavior while maintaining system stability and predictability.

The method 650 may then advance to step 660, which involves monitoring system performance metrics and automatically adjusting autonomy levels. This step may establish continuous oversight mechanisms that track key performance indicators and make real-time adjustments to the level of autonomous operation based on current system capabilities and environmental conditions. The performance monitoring may evaluate metrics such as task success rates, intervention frequency, cycle times, and quality assessments to determine appropriate autonomy levels. The automatic adjustment mechanisms may increase or decrease autonomous operation based on demonstrated performance improvements or degradations.

In some aspects, the autonomy level adjustment may incorporate predictive modeling that anticipates performance changes based on environmental factors, workload variations, or system wear patterns. The monitoring system may utilize machine learning algorithms to identify leading indicators of performance degradation, enabling proactive autonomy adjustments before issues become problematic. The automatic adjustment mechanisms may also implement graduated response protocols that provide multiple levels of autonomy reduction or enhancement, allowing for nuanced control over system behavior. Additionally, the performance monitoring may include comparative analysis that benchmarks current performance against historical baselines or peer systems, providing context for autonomy adjustment decisions. This intelligent autonomy management approach may optimize the balance between operational efficiency and system reliability while adapting to changing conditions and capabilities.

Step 662 may involve preventing regression through performance validation gates and rollback mechanisms. This final step may establish safeguards that protect against the deployment of system updates that could degrade performance or introduce operational risks. The performance validation gates may implement automated testing procedures that verify new models or parameter updates meet minimum performance criteria before deployment. The rollback mechanisms may enable rapid reversion to previous system configurations if performance degradation is detected after deployment.

In some cases, the regression prevention system may incorporate multi-stage validation processes that test updates in progressively more realistic environments before full deployment. The system may utilize canary deployment strategies that gradually roll out updates to subsets of robotic systems while monitoring their performance for signs of regression. The validation gates may also implement ensemble testing approaches that evaluate updates across multiple performance dimensions and operational scenarios to ensure comprehensive validation. Additionally, the rollback mechanisms may include automated trigger conditions that can initiate rollbacks without human intervention when problematic performance thresholds are exceeded. This comprehensive regression prevention framework may ensure that system improvements are implemented safely while maintaining operational continuity and reliability.

In some aspects, the method 650 may also include additional steps or variations to enhance its functionality and robustness. For example, the data processing phase may incorporate federated learning techniques that enable collaborative improvement across multiple robotic installations while preserving data privacy. The shadow model validation may include explainable AI components that provide insights into why certain models perform better than others. The store-and-forward implementation may incorporate edge computing capabilities that enable local processing and decision-making during connectivity outages. The behavior tree updating may include simulation-based validation that tests parameter changes in virtual environments before deployment. The autonomy adjustment phase may incorporate human operator preferences and expertise levels in determining appropriate autonomy levels. The regression prevention phase may include predictive failure analysis that identifies potential issues before they manifest in operational performance. These variations may enhance the effectiveness of the intervention data processing and system behavior updating process, enabling more reliable and efficient evolution of robotic capabilities.

This comprehensive approach to processing intervention data and updating system behavior may enable continuous improvement of robotic capabilities in food service environments while maintaining the high standards of quality, safety, and efficiency desired in commercial kitchen operations.

This continuous learning and improvement process may allow the robotic system to consistently enhance its performance in meal kit preparation and dish handling tasks, adapting to new recipes, dietary requirements, and kitchenware designs while maintaining high quality standards in the dynamic commercial kitchen environment. The improved skills stored in the knowledge base may then be accessed by other robotic arms in the kitchen or transferred to different food service operations that require similar precision in food preparation or dish handling techniques.

In some aspects, the system 100 may also include an explainable AI module. This module may be configured to generate explanations for the decisions made by the robotic systems. The explanations may be based on the input data, the processed information from the foundation model integration module, and the operational data from the robotic control module. The explainable AI module may provide a transparency interface, which may present the explanations in a user-friendly format. This interface may allow human operators or other users to understand why certain actions are taken by the robotic systems, facilitating trust, troubleshooting, and further refinement of the system's behavior.

In some cases, the explainable AI module may utilize various techniques to generate the explanations. For example, it may use feature importance analysis to identify the influential inputs or factors in a decision. It may also use counterfactual analysis to explore alternative outcomes based on different input scenarios. In some aspects, the explainable AI module may use rule extraction techniques to translate the decision-making process into a set of understandable rules or guidelines. These techniques may enhance the transparency and interpretability of the robotic systems, enabling users to understand and interact with the systems more effectively.

In addition to the explainable AI module, the system 100 may also include a DevOps system. This system may be configured to manage the development, deployment, and maintenance of the robotic software. The DevOps system may utilize prompt-engineering techniques to streamline the software management process. For instance, it may use natural language prompts to generate code for new features or bug fixes, significantly reducing the time and technical expertise for software maintenance.

The DevOps system may also include deployment management capabilities. These capabilities may allow for quick and efficient deployment of software updates or changes to the robotic systems. The deployment management may ensure that the robotic systems are running an up-to-date version of the software, enhancing their performance and reliability.

In some aspects, the DevOps system may include version control capabilities. These capabilities may allow for tracking and managing different versions of the software, facilitating rollback or recovery in case of errors or issues. The version control may also support collaborative development, allowing multiple developers to work on the software simultaneously without overwriting each other's changes.

In some cases, the DevOps system may be integrated with the system server 112 or may be implemented as a separate component within the system 100. The integration with the system server 112 may allow for centralized management and control of the software across multiple robotic systems. On the other hand, a separate implementation may allow for more flexibility and scalability, enabling the DevOps system to adapt to different system configurations or operational requirements.

These additional components, namely the explainable AI module and the DevOps system, may enhance the explainability, transparency, and software management capabilities of the robotic control system. They may contribute to the overall effectiveness and usability of the system 100, enabling it to learn and adapt more effectively in various operational contexts.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system for robotic skill learning and adaptation, comprising:
a processor configured to execute:
a multimodal input processing module configured to receive and integrate inputs including visual data from multimodal control sources for controlling robotic platforms;
a foundation model integration module configured to process the integrated inputs from the multimodal input processing module to enhance robotic task planning and execution capabilities using large language models and computer vision algorithms;
a robotic control module configured to direct robotic movements based on the processed input from the foundation model integration module;
a quality control module configured to perform real-time quality assessment during operation of the robotic platform;
a shareable knowledge base configured to retrieve and store robotic task execution data from the foundation model integration module and the robotic control module, and providing the robotic task execution data to the robotic platforms upon request; and
a continuous learning module configured to adapt robotic behavior across multiple robotic platforms by analyzing data from the robotic control module and the quality control module, updating the shareable knowledge base, and controlling the robotic control module to modify robotic control parameters based on the updated knowledge base.

2. The system of claim 1, wherein the multimodal input processing module is configured to select between plane segmentation-based grasp planning and model-based pose estimation using a three-dimensional mesh library based on object characteristics and occlusion conditions.

3. The system of claim 1, wherein the processor comprises a dual-environment processing architecture with edge processing components configured for real-time robotic control operations and cloud-based components configured for model training and knowledge base updates.

4. The system of claim 1, wherein the quality control module is further configured to perform defect detection and contamination assessment using computer vision algorithms trained on domain-specific datasets.

5. The system of claim 1, wherein the continuous learning module is configured to incrementally increase autonomous operation levels based on intervention rate metrics, grasp success rates, and cycle time performance data.

6. The system of claim 1, wherein the shareable knowledge base comprises a versioned three-dimensional mesh library for domain-specific objects and cross-platform adaptation logic for transferring skills between the robotic platforms.

7. The system of claim 1, wherein the continuous learning module is configured to track intervention rates and manipulation success metrics, and a feedback integration component configured to request and process human operator manipulations of the robotic platform.

8. The system of claim 7, wherein the continuous learning module is configured to update manipulation strategies and quality assessment parameters in the shareable knowledge base based on a performance of the robotic platform.

9. The system of claim 1, wherein the processor is configured to execute a behavior tree control framework configured to orchestrate manipulation sequences including object detection, grasp planning, quality assessment, and containerization operations.

10. The system of claim 1, wherein the system is configured for domain-configurable operation across a plurality of industrial applications including at least one of dishware handling, food service automation, and manufacturing assembly tasks.

11. A method for robotic skill learning and adaptation, comprising:
receiving and integrating inputs including visual data from multimodal control sources for controlling robotic platforms;
processing the integrated inputs to enhance robotic task planning and execution capabilities using large language models and computer vision algorithms;
directing robotic movements based on the processed input;
performing real-time quality assessment during operation of the robotic platform;
retrieving and storing robotic task execution data and providing the robotic task execution data to the robotic platforms upon request; and
adapting robotic behavior across multiple robotic platforms by analyzing data from the robotic control and the quality assessment, updating a knowledge base, and modifying robotic control parameters based on the updated knowledge base.

12. The method of claim 11, further comprising receiving and integrating inputs by selecting between plane segmentation-based grasp planning and model-based pose estimation using a three-dimensional mesh library based on object characteristics and occlusion conditions.

13. The method of claim 11, further comprising processing the integrated inputs by executing a dual-environment processing architecture with edge processing components for real-time robotic control operations and cloud-based components for model training and knowledge base updates.

14. The method of claim 11, further comprising performing real-time quality assessment by performing defect detection and contamination assessment using computer vision algorithms trained on domain-specific datasets.

15. The method of claim 11, further comprising adapting robotic behavior by incrementally increasing autonomous operation levels based on intervention rate metrics, grasp success rates, and cycle time performance data.

16. The method of claim 11, further comprising retrieving and storing robotic task execution data by maintaining a versioned three-dimensional mesh library for domain-specific objects and cross-platform adaptation logic for transferring skills between the robotic platforms.

17. The method of claim 11, further comprising adapting robotic behavior by tracking intervention rates and manipulation success metrics, and requesting and processing human operator manipulations of the robotic platform.

18. The method of claim 17, further comprising adapting robotic behavior by updating manipulation strategies and quality assessment parameters in the knowledge base based on a performance of the robotic platform.

19. The method of claim 11, further comprising executing a behavior tree control framework to orchestrate manipulation sequences including object detection, grasp planning, quality assessment, and containerization operations.

20. The method of claim 11, further comprising deploying a domain-configurable operation across a plurality of industrial applications including at least one of dishware handling, food service automation, and manufacturing assembly tasks.
